(19) United States
(12) Patent Application Publication
(10) Pub. No.: US 2013/0116916 A1
(43) Pub. Date: May 9, 2013

(54) TRANSPORTATION NETWORK SCHEDULING SYSTEM AND METHOD

(71) Applicant: Joel Kickbusch, Melbourne, FL (US)

(72) Inventor: Joel Kickbusch, Melbourne, FL (US)

(21) Appl. No.: 13/289,532

(22) Filed: Nov. 4, 2011

(51) Int. Cl. G08G 1/00

(52) U.S. Cl. 701/118; 701/117

(57) ABSTRACT

A method includes determining candidate schedules for plural vehicles traveling in a transportation network comprising and identifying a gridlock area in the transportation network by simulating travel of the vehicles according to the candidate schedules. The gridlock area includes a geographic subset of the transportation network during a time window having at least a predetermined number of failed candidate schedules that result in a decrease of a throughput parameter. The throughput parameter represents flow of travel of the vehicles in the transportation network. The method also includes determining an alternate schedule that differs from the candidate schedule for one or more of the plural vehicles (e.g., a first vehicle of the plural vehicles) that is traveling through the gridlock area. The alternate schedule dictates travel of the one or more of the plural vehicles (e.g., the first vehicle) without decreasing the throughput parameter of the transportation network.

### BACKGROUND

A transportation network for vehicles can include several interconnected main routes on which separate vehicles travel between locations. For example, a transportation network may be formed from interconnected railroad tracks with rail vehicles traveling along the tracks. The vehicles may travel according to schedules that dictate where and when the vehicles are to travel in the transportation network. The schedules may be coordinated with each other in order to arrange for certain vehicles to arrive at various locations in the transportation network at desired times and/or in a desired order.

The schedules may be created so that certain vehicles arrive at associated destination locations earlier than other vehicles. For example, various shipping contracts may associate greater value with the travel of some vehicles than other vehicles. The schedules of several vehicles may be coordinated so that the vehicles having higher values associated therewith may have greater priority in traveling through the transportation network.

However, creating the schedules based on such values may not result in feasible schedules. For example, generating the schedules based on relative values of the goods transported by the vehicles may result in some of the vehicles becoming deadlocked in the transportation network, such as by being unable to move due to other vehicles obstructing the movement of the vehicles. As a result, overall movement and flow of the vehicles in the transportation network is decreased, which can result in all of the vehicles arriving at scheduled destinations much later than desired.

Additionally, some transportation networks have multiple scheduling systems that separately coordinate travel of vehicles traveling in different areas of the transportation network. The scheduling systems may communicate with each other regarding when vehicles leaving one area are scheduled to arrive in another area. But, if one or more vehicles deviate from traveling according to previously created schedules in one area, the schedules for those vehicles may no longer be applicable for travel in another area. As a result, travel of the vehicles in the area that receives the vehicles that deviate from their schedules may be significantly disrupted and slowed.

A need exists for a system and method that creates and/or modifies schedules to avoid significant disruptions in travel of vehicles in a transportation network and/or between different areas of a transportation network.

### BRIEF DESCRIPTION

In one embodiment, a method is provided that includes determining candidate schedules for plural vehicles traveling in a transportation network comprising interconnected routes over which the vehicles concurrently travel and identifying a gridlock area in the transportation network by simulating travel of the vehicles according to the candidate schedules. The gridlock area includes a geographic subset of the transportation network during a time window having at least a predetermined number of failed candidate schedules that result in a decrease of a throughput parameter. The throughput parameter represents flow of travel of the vehicles in the transportation network. The method also includes determining an alternate schedule that differs from the candidate schedule for one or more of the plural vehicles (e.g., a first vehicle of the plural vehicles) that is traveling through the gridlock area. The alternate schedule dictates travel of the one or more of the plural vehicles (e.g., the first vehicle) without decreasing the throughput parameter of the transportation network.

In another embodiment, a system is provided that includes a scheduling module, a detection module, and a resolution module. As used herein, the term “module” includes a hardware and/or software system that operates to perform one or more functions. For example, a module may include a computer processor, controller, or other logic-based device that performs operations based on instructions stored on a tangible and non-transitory computer readable storage medium, such as a computer memory. Alternatively, a module may include a hard-wired device that performs operations based on hard-wired logic of the device. The modules shown in the attached figures may represent the hardware that operates based on software or hardwired instructions, the software that directs hardware to perform the operations, or a combination thereof.

The scheduling module is configured to determine candidate schedules for plural vehicles traveling in a transportation network comprising interconnected routes over which the vehicles concurrently travel. The detection module is configured to identify a gridlock area in the transportation network by simulating travel of the vehicles in the transportation network according to the candidate schedules. The gridlock area includes a geographic subset of the transportation network during a time window having at least a predetermined number of failed candidate schedules that result in a decrease of a throughput parameter representative of flow of travel of the vehicles traveling through the transportation network. The resolution module is configured to determine alternate schedules that differ from the candidate schedules for one or more of the plural vehicles that are traveling through the gridlock area. The alternate schedules dictate travel of said one or more of the plural vehicles without decreasing the throughput parameter.

In another embodiment, another method is provided that includes receiving an exit set of schedules associated with vehicles leaving a first geographic area of a transportation network comprising interconnected routes over which the vehicles travel, receiving an entrance order in which the vehicles are scheduled to enter into a different, second geographic area of the transportation network, and determining a boundary set of schedules for the vehicles to travel in a geographic boundary area of the transportation network that is disposed between the first geographic area and the second geographic area. The boundary set of schedules coordinate travel of the vehicles between the first geographic area and the second geographic area such that the entrance order of the vehicles into the second geographic area is maintained when the vehicles deviate from the exit set of schedules.

In another embodiment, another system is provided that includes a communication module and a scheduling module. The communication module is configured to receive an exit set of schedules associated with vehicles leaving a first geographic area of a transportation network comprising interconnected routes over which the vehicles travel and configured to receive an entrance order in which the vehicles are scheduled to enter into a different, second geographic area of the transportation network. The scheduling module is configured to determine a boundary set of schedules for the vehicles to travel in a geographic boundary area of the transportation network that is disposed between the first geographic area and the second geographic area. The scheduling module also is configured to coordinate travel of the vehicles between the first geographic area and the second geographic area such that the entrance order of the vehicles into the second geographic area is maintained when the vehicles deviate from the exit set of schedules.

### BRIEF DESCRIPTION OF THE DRAWINGS

The present inventive subject matter will be better understood from reading the following description of non-limiting embodiments, with reference to the attached drawings, wherein below:

FIG. 1 is a schematic diagram of one embodiment of a transportation network;

FIG. 2 is a schematic diagram of one embodiment of a scheduling system shown in FIG. 1;

FIG. 3 is a schematic diagram of a simulation of movement of several vehicles in the transportation network shown in FIG. 1 at a first point in time of a simulation;

FIG. 4 is a schematic diagram of the simulation of movement of several vehicles in the transportation network shown in FIG. 1 at a subsequent, second point in time of the simulation;

FIG. 5 is a schematic diagram of a gridlock area shown in FIG. 4 in the transportation network of FIG. 1 in a simulation prior to the vehicles entering into the gridlock area;

FIG. 6 is a schematic diagram of the gridlock area shown in FIG. 4 in the transportation network of FIG. 1 in the simulation after the vehicles exit the gridlock area;

FIG. 7 is a schematic diagram of another embodiment of a transportation network;

FIGS. 8 through 10 provide schematic diagrams of a portion of the transportation network shown in FIG. 7 at different points in time according to one embodiment;

FIG. 11 illustrates a flowchart of one embodiment of a method for generating schedules for vehicles to travel in a transportation network; and

FIG. 12 is a flowchart of one embodiment of a method for generating schedules for vehicles to travel in a transportation network.

### DETAILED DESCRIPTION

One or more embodiments of the subject matter described herein provide systems and methods for creating a movement plan for vehicles to travel through one or more transportation networks. The vehicles can include powered units capable of self propulsion, such as locomotives, trains having one or more locomotives, other off-highway vehicles (e.g., mining vehicles), automobiles, marine vessels, airplanes, and the like. The transportation network may be formed from a plurality of interconnected routes, such as interconnected tracks, roads, shipping paths, flight paths, and the like. While the discussion herein focuses on rail vehicles and railroad tracks, as described above, one or more embodiments also may apply to other types of vehicles, routes, and/or transportation networks.

The movement plan includes schedules for at least some of the vehicles to travel through one or more transportation networks. By “through,” it is meant that the movement plan may direct one or more of the vehicles to travel from a starting location to a destination location, wherein both the starting location and the destination location are disposed in the same transportation network or in different transportation networks. The transportation networks may extend or encompass relatively large amounts of area, such as several hundred square miles or kilometers. Alternatively, the transportation networks may extend over smaller areas. The transportation networks may be arbitrarily defined, or may be defined by geographic areas (referring to both land and political areas, e.g., areas defined by the boundaries of towns, cities, counties, states, countries, mountains, or lakes, oceans, rivers, or other bodies of water, or the like), by the types of routes (e.g., a first transportation network having single tracks as routes and a second transportation network having dual or side-by-side tracks as routes), or by other criteria.

The movement plan can include schedules for vehicles that travel in one or more of the transportation networks. The schedules may dictate destination locations and associated arrival times to which the vehicles are to travel. In one embodiment, the schedules may include interactions between different vehicles. For example, a first schedule of a mining vehicle may direct the mining vehicle to travel to a first destination location at a first arrival time. A second schedule of a train may direct the train to travel to the same first destination at or around the first arrival time so that the mining vehicle can transfer mined product to the train. The second schedule may further direct the train to travel to a second destination location (such as a marine port) at a third arrival time. A third schedule may direct a mining vessel to travel to the third destination location at or around the third arrival time to receive the mined product from the train. The third schedule may further direct the mining vessel to travel to a fourth destination in order to convey the mined product along a supply line, for example.

In one embodiment, a movement plan is created and travel of the vehicles according to the movement plan is simulated. The travel may be simulated in order to determine if travel according to the schedules of the movement plan would (or would be likely to) cause any problems, such as two or more vehicles being unable to travel due to the vehicles or other vehicles blocking continued movement, a relatively large density of vehicles in a geographic subset of the transportation network, a geographic subset of the transportation network where one or more vehicles slow down such that the vehicles are behind associated schedules, and the like. The geographic subset of a transportation network where such as problem is discovered in a simulation may be referred to as a gridlock area. The simulated time period over which the gridlock area occurs or is identified in the simulation may be referred to as a gridlock time window.

In order to avoid or prevent the gridlock area from occurring, the schedules of the vehicles may be modified by backtracking from the location and/or time of the gridlock area in the simulation. For example, a simulation of a movement plan may run until a predesignated number of vehicles become unable to move, such as when two or more vehicles become unable to move because of the positions and/or directions of travel of the vehicles relative to each other and/or to one or more other vehicles. Such a scenario can be referred to as a deadlock condition of the vehicles. The simulation may then run in reverse (e.g., temporally progress backward in time) for one or more of the vehicles through one or more control points of the vehicles. A control point represents a time and/or location in simulated travel of a vehicle where the vehicle can take one of several actions. For example, a control point may represent a “fork in the road” or a decision point where the vehicle has a choice of two or more options related to travel. Examples of control points include an intersection of two or more routes that the vehicle can select from to travel along, a siding section of a route where the vehicle can pull off of the route to wait for a period of time, or the like.

By backtracking, the simulation can run in reverse, with the simulated movement of the vehicle effectively “backing up” to one or more previous control points. The simulation may then proceed by having the vehicle take a different option than when the simulation previously ran and ended up with the gridlock area. For example, if a vehicle takes a first route at a control point representative of an intersection between the first route and a second route, and taking the first route in a simulation ended up in a gridlock area, then the simulation may backtrack the travel of the vehicle back to the control point. The simulation may then proceed again with the vehicle taking the second route at the control point. The simulation may be similarly backtracked for other vehicles involved in the gridlock area. The simulation may be backtracked for several vehicles and/or several control points until the deadlock does not occur when the simulation runs in the normal (e.g., forward in time) direction.

A gridlock area of a simulation of a movement plan may be identified in one or more ways. As one example, a gridlock area may be identified when the number of times that the simulation is backtracked due to identification of a deadlock between vehicles exceeds an associated threshold. Alternatively, a gridlock area may be identified when a density of vehicles exceeds an associated threshold. In one embodiment, when a gridlock area is identified in a simulation, the geographic subset of the transportation network that is encompassed by the gridlock area is identified. A boundary that at least partially defines the gridlock area is determined and an incoming order of the vehicles traveling into the gridlock area across the boundary is identified. An outgoing order of the vehicles traveling out of the gridlock area across the boundary may be identified. An algorithm may be used to simulate different sets of movements of the vehicles within the gridlock area (e.g., within the boundary) while maintaining the incoming order and/or outgoing order of the vehicles. One or more of the sets of simulated movements of the vehicles within the gridlock area may be identified as a solution. For example, a set of movements that is a solution may be the movements that result in the vehicles traveling through the gridlock area without the vehicles being prevented from moving (e.g., deadlocked from moving).

The solution that includes set of simulated movements may be used to modify the schedules of the vehicles. For example, the schedules of the vehicles may be modified to include the solution set of movements. The schedules may then be communicated to the vehicles so that the vehicles can actually travel through the transportation network according to the schedules that include the solution set. These modified schedules may prevent the gridlock area from actually occurring when the vehicles travel in the transportation network.

In another embodiment, multiple movement plans may be created for multiple interconnected transportation networks. For example, a first movement plan may be generated for a first transportation network and a second movement plan may be generated for a second transportation network. The transportation networks may border each other, such as by being adjacent to each other, may partially overlap each other, or may be separated from each other. One or more vehicles can travel from the first transportation network to the second transportation network. While in the first transportation network, the vehicles may travel according to schedules of the first movement plan and while in the second transportation network, the vehicles may travel according to schedules of the second movement plan. The first and second movement plans may differ, such as by having different orders in which the vehicles leave the first transportation network and enter into the second transportation network. However, other differences between the movement plans may exist.

In order to coordinate the differences between the movement plans, a boundary region between the transportation networks may be defined and a set of schedules for movement by the vehicles in the boundary region may be created. The set of schedules associated with the boundary region may coordinate movements of the vehicles such that the vehicles maintain the order in which the vehicles leave the first transportation network and in which the vehicles enter into the second transportation network. The times at which the vehicles enter into the second transportation network may deviate from the movement plan generated for the second transportation network, but the order of entry into the second transportation network remains the same. A scheduling system associated with the second transportation network may modify the schedules of the vehicles traveling in the second transportation network by changing the times, but not the order, in which the vehicles enter into the second transportation network. Changing the times instead of the order of entry by the vehicles may reduce the computational costs and/or time involved in generating or modifying the schedules for travel in the second transportation network.

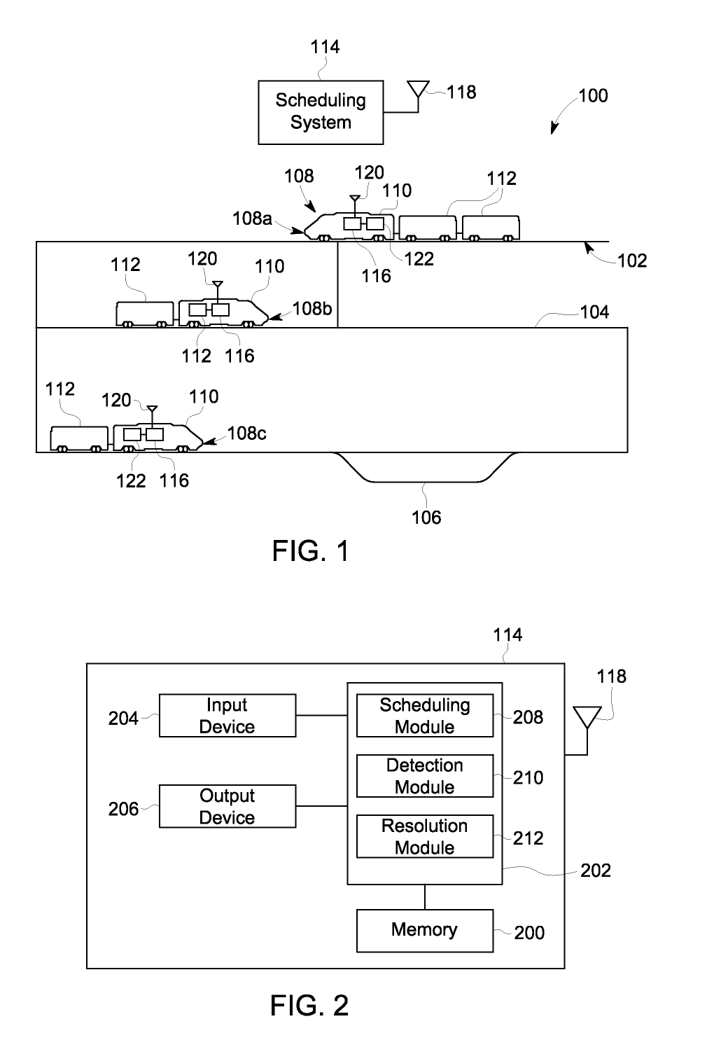

FIG. 1 is a schematic diagram of one embodiment of a transportation network 100. The transportation network 100 includes a plurality of interconnected routes 102. While only one transportation network 100 is shown in FIG. 1, one or more other transportation networks 100 may be joined with and accessible to vehicles traveling in the illustrated transportation network 100. For example, one or more of the routes 102 may extend to another transportation network 100 such that vehicles can travel between the transportation networks 100. Different transportation networks 100 may be defined by different geographic boundaries, such as different towns, cities, counties, states, groups of states, countries, continents, and the like.

The illustrated routes 102 include main line routes 104 and siding section routes 106. The main line routes 104 may represent railroad tracks, roads, shipping paths, and the like, and the siding section routes 106 may represent relatively short diversions off of the main line routes 104. For example, the siding section routes 106 may represent smaller or lighter tracks, roads, paths, and the like. In one embodiment, the siding section routes 106 can be used in events between vehicles 108 traveling in the transportation network 100. If a main line route 104 can only allow for a single vehicle 108 to pass over a section of the main line route 104 in a single direction (e.g., a single railroad track), then two vehicles 108 can pass one another using the siding section route 106. For example, one of the vehicles 108 can pull off of the main line route 104 and onto the siding section route 106 to allow another vehicle 108 to pass (e.g., either in the same or opposite direction) on the main line route 104 before pulling back onto the main line route 104. The number of routes 102 shown in FIG. 1 is meant to be illustrative and not limiting on embodiments of the described subject matter.

Several vehicles 108 travel along the routes 102 in the transportation network 100. The vehicles 108 may concurrently travel in the transportation network 100 along the same or different routes 102. Travel of one or more vehicles 108 may be constrained to travel within the transportation network 100 (referred to herein as “intra-network travel”). Alternatively, one or more of the vehicles 108 may enter the transportation network 100 from another transportation network or leave the transportation network 100 to travel into another transportation network (referred to herein as “inter-network travel”). In the illustrated embodiment, the vehicles 108 are shown and described herein as rail vehicles or rail vehicle consists. However, one or more other embodiments may relate to vehicles other than rail vehicles or rail vehicle consists. The vehicles 108 are individually referred to by the reference numbers 108a, 108b, and 108c. While three vehicles 108 are shown in FIG. 1, alternatively, a different number of vehicles 108 may be concurrently traveling in the transportation network 100. A vehicle 108 may include a group of powered units 110 (e.g., locomotives or other vehicles capable of self-propulsion) and/or non-powered units 112 (e.g., cargo cars, passenger cars, or other vehicles incapable of self-propulsion) that are mechanically coupled or linked together to travel along the routes 102.

A movement plan for the vehicles 108 traveling in the transportation network 100 may be determined by a scheduling system 114. The scheduling system 114 can include one or more devices, controllers, and the like, having hardware and/or software components that operate to provide various functions. As shown in FIG. 1, the scheduling system 114 can be disposed off-board (e.g., outside) the vehicles 108. For example, the scheduling system 114 may be disposed at a central dispatch office for a railroad company. The scheduling system 114 can create and communicate the schedules to the vehicles 108. The scheduling system 114 can include a wireless antenna 118, such as a radio frequency (RF) or cellular antenna, that wirelessly transmits the schedules to the vehicles 108. (As used herein, the term wireless antenna includes associated electronic transceiver equipment.) For example, the scheduling system 114 may transmit destination locations and associated arrival times to the vehicles 108. Alternatively, the scheduling system 114 may communicate the schedules to the vehicles 108 via another medium, such as through one or more conductive pathways (e.g., wires, cables, the rails of a railroad track, an overhead catenary, or the like).

The vehicles 108 include control systems 116 disposed on-board the vehicles 108. The control systems 116 receive the schedules from the scheduling system 114 and generate control signals that may be used to control propulsion of the vehicles 108 through the transportation network 100. For example, the vehicles 108 may include wireless antennas 120, such as RF or cellular antennas, that receive the schedules from the scheduling system 114. The control systems 116 on the vehicles 108 examine the schedules, such as by determining the scheduled destination location and scheduled arrival time for the respective vehicle 108, and generate control signals based on the schedules.

The vehicles 108 include propulsion subsystems 122, such as engines, traction motors, brake systems, and the like, that generate tractive effort to propel the vehicles 108 and braking effort to slow down or stop movement of the vehicles 108. The control signals generated by the control systems 116 may be used to automatically control tractive efforts and/or braking efforts provided by the propulsion subsystems 122 such that the vehicle 108 self-propels along the routes 102 to the destination location. The control signals may automatically control the propulsion subsystems 122, such as by automatically changing throttle settings and/or brake settings of the propulsion subsystems 122. Alternatively, the control signals may be used to prompt an operator of the vehicle 108 to manually control the tractive efforts and/or braking efforts of the vehicle 108. For example, the control system 116 may include an output device, such as a computer monitor, touchscreen, acoustic speaker, or the like, that generates visual and/or audible instructions based on the control signals. The instructions may direct the operator to manually change throttle settings and/or brake settings of the propulsion subsystem 122 of the vehicle 108.

As described herein, the scheduling system 114 generates a movement plan having candidate schedules for the vehicles 108 traveling in the transportation network 100. The scheduling system 114 can simulate movement of the vehicles 108 according to the candidate schedules in order to determine gridlock areas in the transportation network. The scheduling system 114 may determine an alternate schedule for one or more of the vehicles 108 involved in (e.g., deadlocked in) the gridlock area. For example, the scheduling system 114 may modify the candidate schedules by changing destination locations and/or associated scheduled arrival times of one or more of the vehicles 108, and/or may change along which routes 102 the vehicles 108 travel. The scheduling system 114 can determine the alternate schedules that prevent or avoid causing the gridlock area in the simulation and communicate the alternate schedules to the corresponding vehicles 108. The vehicles 108 may then travel according to the alternate schedules.

FIG. 2 is a schematic diagram of one embodiment of the scheduling system 114. The scheduling system 114 includes several modules that perform various operations or functions described herein. The modules may include hardware and/or software systems that operate to perform one or more functions, such as one or more computer controllers (e.g., processors or other circuitry) and/or one or more sets of instructions. The modules shown in FIG. 2 may represent the hardware (e.g., a computer processor) and/or software (e.g., one or more sets of instructions such as software applications or hard-wired logic) used to perform the functions or operations associated with the modules. A single hardware component (e.g., a single processor) and/or software component may perform the operations or functions of several modules, or multiple hardware components and/or software components may separately perform the operations or functions associated with different modules. The instructions on which the hardware components operate may be stored on a tangible and non-transitory (e.g., not a transient signal) computer readable storage medium, such as a memory 200. The memory 200 may include one or more computer hard drives, flash drives, RAM, ROM, EEPROM, and the like. Alternatively, one or more of the sets of instructions that direct operations of the hardware components may be hard-wired into the logic of the hardware components, such as by being hard-wired logic formed in the hardware of a processor or controller.

The scheduling system 114 includes a controller 202 that provides the functions performed by the modules described herein. The controller 202 can represent a single or multiple computing devices, such as processors, that operate based on the set of instructions stored on the memory 200. The modules are illustrated as being part of the controller 202, but alternatively may not be part of the controller 202 (e.g., another component may perform the functions associated with the modules).

The controller 202 is communicatively coupled with an input device 204 and an output device 206 by one or more wired and/or wireless connections (e.g., cables, wires, busses, wireless networks, and the like). The input device 204 can include one or more components that receive input from an operator, such as an electronic mouse, keyboard, keypad, touchscreen, stylus, microphone, or the like. The input can include information related to destinations of the vehicles 108 (shown in FIG. 1), selected arrival times for the vehicles 108, relative priorities between the vehicles 108, and the like. The input may be used by the scheduling system 114 to form the schedules for the vehicles 108. The output device 206 can include one or more components that presents information to the operator, such as a monitor, touchscreen (e.g., the input device and the output device can be the same component), speakers, printer, or the like. The output device 206 may provide information such as candidate schedules, modifications to the schedules, alternate schedules, and the like, to the operator.

With respect to the modules of the scheduling system 114, a scheduling module 208 creates schedules for the vehicles 108 (shown in FIG. 1). For example, the scheduling module 208 may generate a set of candidate schedules for vehicles 108 traveling in the transportation network 100 (shown in FIG. 1).

In one embodiment, the scheduling module 208 coordinates the candidate schedules so that the flow of traffic (e.g., the travel of the vehicles 108 shown in FIG. 1) through the transportation network 100 (shown in FIG. 1) is not significantly impeded. The flow of traffic may be represented by a throughput parameter associated with the transportation network 100 or with a geographic subset of the transportation network 100. In one embodiment, the throughput parameter can indicate how successful the vehicles 108 are in traveling according to the schedule associated with each vehicle 108. For example, the throughput parameter can be a statistical measure of adherence by one or more of the vehicles 108 to the schedules of the vehicles 108 in the movement plan. The term “statistical measure of adherence” can refer to a quantity that is calculated for a vehicle 108 and that indicates how closely the vehicle 108 is following the schedule associated with the vehicle 108. Several statistical measures of adherence to the movement plan may be calculated for the vehicles 108 traveling in the transportation network 100.

In one embodiment, larger throughput parameters represent greater flow of the vehicles 108 through the transportation network 100, such as what may occur when a relatively large percentage of the vehicles 108 adhere to the associated schedules and/or the amount of congestion in the transportation network 100 are relatively low. Congestion can include or be an estimate or measure of vehicle density (e.g., number of vehicles per unit area of space usable for vehicle travel, within a given region) and/or vehicle interaction, e.g., a slowdown in traffic speed due to vehicle interaction. Conversely, smaller throughput parameters may represent reduced flow of the vehicles 108 through the transportation network 100. The throughput parameter may reduce in value when a lower percentage of the vehicles 108 follow the associated schedules and/or the amount of congestion in the transportation network 100 is relatively large.

The scheduling module 208 can monitor locations of the vehicles 108 (shown in FIG. 1) as the vehicles 108 travel through the transportation network 100 (shown in FIG. 1). The vehicles 108 may periodically report current positions of the vehicles 108 to the scheduling system 114. Alternatively, signals or other sensors disposed alongside the routes 102 (shown in FIG. 1) of the transportation network 100 can periodically report the passing of vehicles 108 by the signals or sensors to the scheduling system 114. The scheduling module 208 receives the locations of the vehicles 108 in order to monitor where the vehicles 108 are in the transportation network 100 over time.

In one embodiment, the scheduling module 208 calculates the throughput parameters based on the schedules of the vehicles 108 (shown in FIG. 1) and deviations from the schedules by the vehicles 108. For example, in order to determine a statistical measure of adherence to the schedule associated with a vehicle 108, the scheduling module 208 may monitor how closely the vehicle 108 adheres to the schedule as the vehicle 108 travels in the transportation network 100 (shown in FIG. 1). The vehicle 108 may adhere to the schedule of the vehicle 108 by proceeding along a path toward the scheduled destination such that the vehicle 108 will arrive at the scheduled destination at the scheduled arrival time. For example, an estimated time of arrival (ETA) of the vehicle 108 may be calculated as the time that the vehicle 108 will arrive at the scheduled destination if no additional anomalies occur that change the speed at which the vehicle 108 travels. If the ETA is the same as or within a predetermined time window of the scheduled arrival time, then the monitoring module 204 may calculate a large statistical measure of adherence for the vehicle 108. As the ETA differs from the scheduled arrival time (e.g., by occurring after the scheduled arrival time), the statistical measure of adherence may decrease.

Alternatively, the vehicle 108 (shown in FIG. 1) may adhere to the schedule by arriving at or passing through scheduled waypoints of the schedule at scheduled times that are associated with the waypoints, or within a predetermined time buffer of the scheduled times. As differences between actual times that the vehicle 108 arrives at or passes through the scheduled waypoints and the associated scheduled times of the waypoints increases, the statistical measure of adherence for the vehicle 108 may decrease. Conversely, as these differences decrease, the statistical measure of adherence may increase.

The scheduling module 208 may calculate the statistical measure of adherence as a time difference between the ETA of a vehicle 108 (shown in FIG. 1) and the scheduled arrival time of the schedule associated with the vehicle 108. Alternatively, the statistical measure of adherence for the vehicle 108 may be a fraction or percentage of the scheduled arrival time. For example, the statistical measure of adherence may be the fraction or percentage that the difference between the ETA and the scheduled arrival time is of the scheduled arrival time. In another example, the statistical measure of adherence may be a number of scheduled waypoints in a schedule of the vehicle 108 that the vehicle 108 arrives at or passes by later than the associated scheduled time or later than a time window after the scheduled time. Alternatively, the statistical measure of adherence may be a sum total, average, median, or other calculation of time differences between the actual times that the vehicle 108 arrives at or passes by scheduled waypoints and the associated scheduled times.

Table 1 below provides examples of statistical measures of adherence of a vehicle 108 to an associated schedule in a movement plan. Table 1 includes four columns and seven rows. Table 1 represents at least a portion of a schedule of the vehicle 108. Several tables may be calculated for different schedules of different vehicles 108 in the movement plan for the transportation network 100 (shown in FIG. 1). The first column provides coordinates of scheduled locations that the vehicle 108 is to pass through or arrive at the corresponding scheduled times shown in the second column. The coordinates may be coordinates that are unique to a transportation network 100 or that are used for several transportation networks (e.g., Global Positioning System coordinates). The numbers used for the coordinates are provided merely as examples. Moreover, information regarding the scheduled location other than coordinates may be used.

TABLE 1

| Scheduled Location | | | |
|---|---|---|---|
| (SL) | Scheduled Time | Actual Time at SL | Difference |
| (123.4, 567.8) | 09:00 | 09:00 | 0 |
| (901.2, 345.6) | 09:30 | 09:33 | (0:03) |
| (789.0, 234.5) | 10:15 | 10:27 | (0:12) |
| (678.9, 345.6) | 10:43 | 10:44 | (0:01) |
| (987.6, 543.2) | 11:02 | 10:58 | 0:04 |
| (109.8, 765.4) | 11:15 | 11:14 | 0:01 |
| (321.0, 987.5) | 11:30 | 11:34 | (0:04) |

The third column includes a list of the actual times that the vehicle 108 (shown in FIG. 1) arrives at or passes through the associated scheduled location. For example, each row in Table 1 includes the actual time that the vehicle 108 arrives at or passes through the scheduled location listed in the first column for the corresponding row. The fourth column in Table 1 includes a list of differences between the scheduled times in the second column and the actual times in the third column for each scheduled location.

The differences between when the vehicle 108 (shown in FIG. 1) arrives at or passes through one or more scheduled locations and the time that the vehicle 108 was scheduled to arrive at or pass through the scheduled locations may be used to calculate the statistical measure of adherence to a schedule for the vehicle 108. In one embodiment, the statistical measure of adherence for the vehicle 108 may represent the number or percentage of scheduled locations that the vehicle 108 arrived too early or too late. For example, the scheduling module 208 may count the number of scheduled locations that the vehicle 108 arrives at or passes through outside of a time buffer around the scheduled time. The time buffer can be one to several minutes. By way of example only, if the time buffer is three minutes, then the monitoring module 204 may examine the differences between the scheduled times (in the second column of Table 1) and the actual times (in the third column of Table 1) and count the number of scheduled locations that the vehicle 108 arrived more than three minutes early or more than three minutes late.

Alternatively, the scheduling module 208 may count the number of scheduled locations that the vehicle 108 (shown in FIG. 1) arrived early or late without regard to a time buffer. With respect to Table 1, the vehicle 108 arrived at four of the scheduled locations within the time buffer of the scheduled times, arrived too late at two of the scheduled locations, and arrived too early at one of the scheduled locations.

The scheduling module 208 may calculate the statistical measure of adherence by the vehicle 108 (shown in FIG. 1) to the schedule based on the number or percentage of scheduled locations that the vehicle 108 arrived on time (or within the time buffer). In the illustrated embodiment, the scheduling module 208 can calculate that the vehicle 108 adhered to the schedule (e.g., remained on schedule) for 57% of the scheduled locations and that the vehicle 108 did not adhere (e.g., fell behind or ahead of the schedule) for 43% of the scheduled locations.

Alternatively, the scheduling module 208 may calculate the statistical measure of adherence by the vehicle 108 (shown in FIG. 1) to the schedule based on the total or sum of time differences between the scheduled times associated with the scheduled locations and the actual times that the vehicle 108 arrived at or passed through the scheduled locations. With respect to the example shown in Table 1, the scheduling module 208 may sum the time differences shown in the fourth column as the statistical measure of adherence. In the example of Table 1, the statistical measure of adherence is −15 minutes, or a total of 15 minutes behind the schedule of the vehicle 108.

In another embodiment, the scheduling module 208 may calculate the average statistical measure of adherence by comparing the deviation of each vehicle 108 from the average or median statistical measure of adherence of the several vehicles 108 traveling in the transportation network 100 (shown in FIG. 1). For example, the scheduling module 208 may calculate an average or median deviation of the measure of adherence for the vehicles 108 from the average or median statistical measure of adherence of the vehicles 108.

The scheduling module 208 may determine the throughput parameters for the transportation network 100 (shown in FIG. 1), or an area thereof, based on the statistical measures of adherence associated with the vehicles 108 (shown in FIG. 1). For example, a throughput parameter may be an average, median, or other statistical calculation of the statistical measures of adherence for the vehicles 108 concurrently traveling in the transportation network 100. The throughput parameter may be calculated based on the statistical measures of adherence for all, substantially all, a supermajority, or a majority of the vehicles 108 traveling in the transportation network 100.

The scheduling module 208 creates schedules for the vehicles 108 (shown in FIG. 1) and transmits the schedules to the control systems 116 (shown in FIG. 1) of the vehicles 108. In one embodiment, the scheduling module 208 conveys the schedules to the antenna 118, which transmits the schedules to the antennas 120 (shown in FIG. 1) of corresponding vehicles 108. The control systems 116 of the vehicles 108 receive the schedules and generate control signals to control propulsion of the vehicles 108 based on the schedules, as described above.

In one embodiment, the scheduling module 208 generates an initial set of candidate schedules for the vehicles 108 (shown in FIG. 1). The candidate schedules may be formed in order to meet one or more criteria, such as by ensuring that the vehicles 108 arrive at selected destination locations in an order that corresponds with relative priorities between the vehicles 108. For example, some vehicles 108 may carry more valuable cargo and may be associated with a higher priority than vehicles 108 carrying less cargo or less valuable cargo. The candidate schedules may be formed so that the higher priority vehicles 108 arrive at associated selected destinations before lower priority vehicles 108 arrive at associated selected destinations.

A detection module 210 simulates travel of the vehicles 108 (shown in FIG. 1) according to the candidate schedules. For example, the detection module 210 may compute the movements and interactions of the vehicles 108 with each other as the vehicles 108 concurrently move in the transportation network 100 (shown in FIG. 1) according to the candidate schedules.

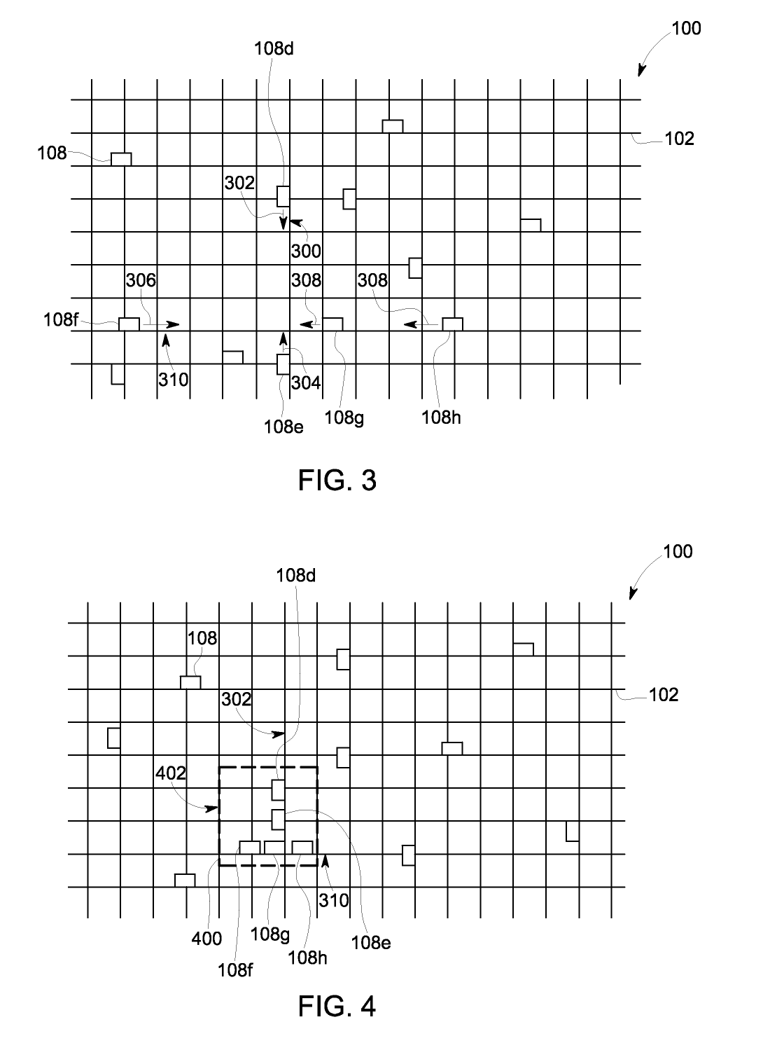

FIG. 3 is a schematic diagram of a simulation of movement of several vehicles 108 in the transportation network 100 at a first point in time of the simulation. The transportation network 100 is schematically shown as a regular grid of the routes 102, but alternatively may include a different number and/or arrangement of the routes 102. Although not shown in FIG. 3, the routes 102 in the grid may include additional intersections, siding section routes, and the like.

Several vehicles 108 are shown concurrently traveling in the simulation of the transportation network 100. The locations of the vehicles 108 at various times in the simulation are based on the candidate schedules of the vehicles 108. The locations of the vehicles 108 shown in FIG. 3 represent the locations of the vehicles 108 at a first point in time during a simulation of movement according to the candidate schedules. As described above, the detection module 210 (shown in FIG. 2) may track the simulated movements of the vehicles 108 in the transportation network 100.

Returning to the discussion of the detection module 210 shown in FIG. 2, the detection module 210 may monitor the simulated travel in order to determine if a gridlock area occurs. The gridlock area may be identified in one or more manners that are related to a decrease in the throughput parameter of the transportation network 100. In one example, the gridlock area may be identified based on a decrease in the throughput parameter associated with the transportation network 100 or with a geographic subset of the transportation network 100. As described above, in one embodiment, a gridlock area may be identified when a set of vehicles are unable to move due to the vehicles blocking each other. The inability to move may cause a decrease in the throughput parameter below a designated threshold. The detection module 210 can identify the gridlock area based on the decrease in the throughput parameter and/or in the determination that the vehicles 108 cannot move according to the associated schedules.

In another example, the gridlock area may be identified by the detection module 210 when a density of the vehicles 108 (shown in FIG. 1) in a geographic subset of the transportation network 100 (shown in FIG. 1) exceeds a predetermined threshold. For example, the detection module 210 may calculate densities of the vehicles 108 as a number and/or size of vehicles 108 per unit area in the transportation network 100. If the density in one or more areas of the transportation network 100 exceeds the threshold, then the detection module 210 may identify the area or areas in which the densities exceed the threshold as gridlock areas.

In another example, the gridlock area may be identified by the detection module 210 when a number of backtracks from a deadlock identified in the simulation exceeds a predetermined threshold. As described above, when a deadlock between two or more vehicles 108 (shown in FIG. 1) is identified, the simulation may run in reverse for one or more of the vehicles 108 and a decision or option taken at one or more previous control points in the simulation may be changed. The simulation may then run in forward order to determine if the changed decision or option results in the deadlock (or another deadlock) occurring. In one embodiment, the reversal of the simulation for a vehicle 108 to a previous control point is referred to as a single backtrack. The number of backtracks associated with a deadlock may be based on the number of vehicles 108 involved in the deadlock and/or the number of control points through which the simulation is backtracked. For example, if three vehicles 108 are involved in a deadlock and the simulation is backtracked to the previous control point for each vehicle 108, then the number of backtracks may be three. As another example, if the simulation is backtracked to the previous control point for a first vehicle 108, to two prior control points for a second vehicle 108, and to the fourth previous control point for a third vehicle 108, then the number of backtracks may be seven. Once the number of backtracks exceeds an associated threshold (such as a threshold stored on the memory 200), then a gridlock area may be identified.

FIG. 4 is a schematic diagram of the simulation of movement of several vehicles 108 in the transportation network 100 at a subsequent, second point in time of the simulation. As shown in FIG. 4, the vehicles 108 have moved and/or changed routes relative to the first point in time of the simulation that is represented in FIG. 3. For example, as shown in FIGS. 3 and 4, a first vehicle 108d may travel along a first route 300 in a first direction 302 from the position shown in FIG. 3 to the position shown in FIG. 4. A second vehicle 108e may travel along the same first route 300 in an opposite second direction 304 from the position in FIG. 3 to the position in FIG. 4. Similarly, third, fourth, and fifth vehicles 108f, 108g, 108h may travel in directions 306, 308 (e.g., the third vehicle 108f traveling in the direction 306 and the fourth and fifth vehicles 108g, 108h traveling in the direction 308) along a second route 310 from the positions of FIG. 3 to the positions of FIG. 4. Other vehicles 108 may travel in different or similar directions and/or on the same or different routes. While the illustrated examples focus on the movements of five vehicles 108d-h, alternatively, a fewer or different number of vehicles 108 may be used to identify the gridlock area 400 and/or change the schedules of the vehicles 108.

With continued reference to the states of the vehicles 108 show in FIGS. 3 and 4, and returning to the discussion of the scheduling system 114 shown in FIG. 2, the detection module 210 identifies a gridlock area 400 (shown in FIG. 4) in the simulation represented by FIGS. 3 and 4. As described above, the gridlock area 400 may be identified by a decrease in a throughput parameter of the transportation network 100. The vehicles 108d-g may be deadlocked in the state shown in FIG. 4. Such a deadlock between the vehicles 108d-g may be represented by a decrease in the throughput parameter. For example, the vehicles 108 may be moving freely (e.g., without a deadlock) in the state represented by FIG. 3. As a result, the state of FIG. 3 may be associated with a relatively high throughput parameter. Conversely, the vehicles 108d-h may not be moving in the state represented by FIG. 4. As a result, the state of FIG. 4 may be associated with a throughput parameter that is smaller than the throughput parameter associated with FIG. 3. This decrease may indicate to the detection module 210 that deadlock has occurred.

The area that is encompassed by the gridlock area 400 may be determined by the detection module 210 by identifying locations of the vehicles 108d-h in the state of FIG. 4. For example, once the deadlock is identified as occurring at the time represented by the state of FIG. 4, the detection module 210 can identify the geographic area encompassed by the vehicles 108d-h in the simulation. Alternatively, the area that is encompassed by the gridlock area 400 may be determined by identifying the geographic area of the transportation network 100 having a density of the vehicles 108 that exceeds a threshold, as described above. For example, the detection module 210 may determine that the gridlock area 400 has a density at the time reflected in FIG. 4 that exceeds the threshold.

The detection module 210 defines a geographic boundary 402 of the gridlock area 400 in one embodiment. The geographic boundary 402 may extend around all or a portion (e.g., less than all) of the perimeter of the gridlock area 400. The geographic boundary 402 may have a variety of shapes, including a square (as shown in FIG. 4), another polygon, a circle, a line (e.g., defining one side of the gridlock area 400), or another geographic shape. The detection module 210 may determine the time window that the gridlock area 400 occurs. For example, the detection module 210 may determine the time at which the throughput parameter of the transportation network 100 falls below a threshold, the time at which deadlock between the vehicles 108 begins, the time at which a density of the vehicles 108 increases above a threshold, and the like. In one embodiment, the detection module 210 may identify the duration of the time window associated with the gridlock area 400, such as by determining how long the throughput parameter remains below the threshold, how long the deadlock lasts, how long the density of the vehicles 108 remains above the threshold, and the like.

The schedules associated with the vehicles 108d-h involved in the gridlock area 400 and/or that are deadlocked may be identified by the detection module 210 as failed schedules. For example, the schedules being simulated by the detection module 210 may be referred to as candidate schedules and the candidate schedules that result in the vehicles 108 being deadlocked (or otherwise causing a gridlock area) may be referred to as failed schedules as these schedules may be unsuitable for use in actual travel by the vehicles 108 in the transportation network 100.

A resolution module 212 of the scheduling system 114 determines one or more alternate schedules for one or more of the vehicles 108 in order to avoid the gridlock area 400. For example, the resolution module 212 may derive one or more changes to the failed schedules of the vehicles 108 (that may or may not include the vehicles 108d-h), where the changes result in the vehicles 108d-h not being deadlocked or otherwise causing identification of the gridlock area 400 in the simulation. The changes to the schedules may include, by way of example, changing an arrival time, a scheduled destination location, a path to be taken by a vehicle 108 between a current or starting location and the destination location, the addition or removal of one or more delays in traveling to the destination location (e.g., by pulling off of a main line route onto a siding section route), and/or changing one or more times at which the vehicle 108 is to arrive or pass by one or more waypoints along the path toward the destination location.

In one embodiment, the resolution module 212 determines alternate schedules for one or more of the vehicles 108 (which may or may not include the vehicles 108d-h in the illustrated example) in order to avoid the gridlock area 400 occurring in the simulation and while avoiding decreasing the throughput parameter of the transportation network 100. For example, if the transportation network 100 has a throughput parameter prior to the gridlock area 400 being detected in the simulation, the resolution module 212 can determine one or more alternate schedules that do not result in the gridlock area 400 occurring and that avoid reducing the throughput parameter. Alternatively, the alternate schedules may avoid the gridlock area 400 but may cause a decrease in the throughput parameter. For example, the alternate schedules may cause a decrease in the throughput parameter that does not result in the throughput parameter decreasing below an associated threshold (such as the threshold used to identify the gridlock area 400).

The alternate schedules that are created by the resolution module 212 may maintain at least one of an entrance order in which two or more of the vehicles 108d-h enter into the gridlock area 400 and/or an exit order in which two or more of the vehicles 108d-h leave the gridlock area 400. For example, in order to avoid disrupting the flow of traffic outside of the gridlock area 400 too much and/or in order to reduce the total number of alternate schedules that are created for the vehicles 108 (e.g., and thereby reduce computational costs involved), the resolution module 212 may ensure that the alternate schedules that avoid the gridlock area 400 occurring keep the same order in which the vehicles 108d-h enter into the gridlock area 400 and/or leave the gridlock area 400 is the same as with the candidate schedules.

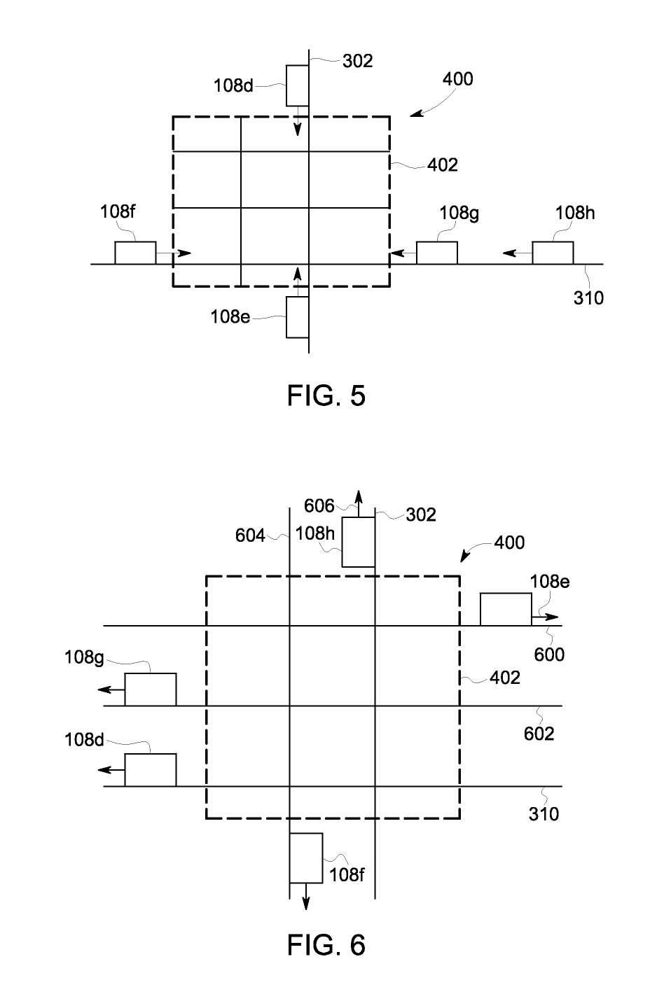

FIG. 5 is a schematic diagram of the gridlock area 400 in the transportation network 100 in a simulation prior to the vehicles 108d-h entering into the gridlock area 400. The diagram of FIG. 5 provides a state of the vehicles 108d-h that corresponds to the example of FIG. 3. In the illustrated example, the entrance order of the vehicles 108d-h into the gridlock area 400 includes the second vehicle 108e entering first, the third vehicle 108f entering second, the first vehicle 108d entering third, the fourth vehicle 108g entering fourth, and the fifth vehicle 108h entering fifth. As shown in FIG. 5, the vehicles 108d-h enter into the gridlock area 400 on different routes 302, 310.

The resolution module 212 can maintain the entrance order of the alternate schedules to correspond to the entrance order of the candidate schedules by keeping the order in which the vehicles 108d-h cross the boundary 402 into the gridlock area 400 the same. For example, the resolution module 212 may create the alternate schedules by changing decisions or options taken by one or more of the vehicles 108d-h at a control point located outside of the gridlock area 400 while keeping the order in which the vehicles 108d-h cross the border 402 into the gridlock area 400 the same.

In one embodiment, the resolution module 212 maintains the entrance order of the vehicles 108d-h into the gridlock area 400 while changing one or more times at which the vehicles 108d-h enter into the gridlock area 400. The time at which a vehicle 108 crosses the boundary 402 into the gridlock area 400 may be referred to as an entry time of the vehicle 108. The resolution module 212 may keep the same entrance order of the vehicles 108d-h in the candidate schedules and the alternate schedules but change the entry times of one or more of the vehicles 108d-h. For example, the entry time of one or more of the vehicles 108d-h may be delayed from a candidate entry time of a candidate schedule to an alternate entry time of an alternate schedule. The alternate entry time may be later or earlier than the candidate entry time. The resolution module 212 may change the entry times by directing one or more of the vehicles 108d-h to move at a slower or faster speed during an approach to the gridlock area 400, move to or avoid moving to a siding section route prior to entering into the gridlock area 400, take a longer and/or different path through the routes 102 to the gridlock area 400, take a shorter path to the gridlock area 400, and the like, in the alternate schedules.

FIG. 6 is a schematic diagram of the gridlock area 400 in the transportation network 100 in a simulation after the vehicles 108d-h exit the gridlock area 400. The diagram of FIG. 6 provides a state of the vehicles 108d-h that corresponds to the example of FIG. 4. In the illustrated example, the exit order of the vehicles 108d-h out of the gridlock area 400 includes the fifth vehicle 108h leaving first, the third vehicle 108f leaving second, the second vehicle 108e leaving third, the first vehicle 108d leaving fourth, and the fourth vehicle 108g leaving fifth.

As shown in FIG. 6, one or more of the vehicles 108d-h leave the gridlock area 400 on different routes 600, 602, 604 than the routes 302, 310 that the vehicles 108d-h enter into the gridlock area 400. Arrows 606 represent the directions that the vehicles 108d-h move as the vehicles 108d-h leave the gridlock area 400. For example, one or more of the vehicles 108d-h may change which routes the vehicles 108d-h travel on within the gridlock area 400 such that one or more of the vehicles 108d-h enter and leave the gridlock area 400 on different routes.

The resolution module 212 can maintain the exit order of the alternate schedules to correspond to the exit order of the candidate schedules by keeping the order in which the vehicles 108d-h cross the boundary 402 out of the gridlock area 400 the same. For example, the resolution module 212 may create the alternate schedules by changing decisions or options taken by one or more of the vehicles 108d-h at one or more control points within the gridlock area 400 while keeping the exit order the same in both the candidate and alternate schedules.

In one embodiment, the resolution module 212 maintains the exit order of the vehicles 108d-h out of the gridlock area 400 while changing one or more times at which the vehicles 108d-h exit out of the gridlock area 400. The time at which a vehicle 108 crosses the boundary 402 out of the gridlock area 400 may be referred to as an exit time of the vehicle 108. The resolution module 212 may keep the same exit order of the vehicles 108d-h in the candidate schedules and the alternate schedules but change the exit times of one or more of the vehicles 108d-h. For example, the exit time of one or more of the vehicles 108d-h may be delayed from a candidate exit time of a candidate schedule to a different alternate exit time of an alternate schedule. The alternate exit time may be later or earlier than the candidate exit time. The resolution module 212 may change the exit times by directing one or more of the vehicles 108d-h to move at a slower or faster speed within the gridlock area 400, move to or avoid moving to a siding section route within the gridlock area 400, take a longer and/or different path through the routes 102 within the gridlock area 400 (e.g., between entry and exit of the gridlock area 400), take a shorter path within the gridlock area 400 (e.g., between entry and exit of the gridlock area 400), and the like, in the alternate schedules.

As described above, the resolution module 212 may generate the alternate schedules for one or more of the vehicles 108 in order to avoid the gridlock area 400 from occurring, such as by avoiding a reduction of a throughput parameter below an associated threshold, by avoiding deadlock between the vehicles 108, and/or by avoiding the density of the vehicles 108 from increasing above an associated threshold. For example, after detecting the gridlock area 400 in a simulation, the resolution module 212 can create alternate schedules for one or more of the vehicles 108 that, when travel of the vehicles 108 according to the alternate schedules is simulated, the gridlock area 400 does not occur or is avoided.

In one embodiment, the scheduling module 208 and the resolution module 212 may create the schedules based on different goals. For example, the scheduling module 208 and the resolution module 212 may create the candidate and alternate schedules based on different goals. A goal may include a designated order in which at least a plurality of the vehicles 108 arrive at associated destination locations. As one example, a goal may include a first vehicle 108 arriving at an associated destination location before a designated time, a second vehicle 108 arriving at the same or different location no later than a subsequent designated time, a third vehicle 108 arriving at the same or different location no later than a later designated time, and the like.

The scheduling module 208 may generate the candidate schedules based on relative priorities between the vehicles 108. The priorities may be assigned to the vehicles 108 based on a variety of factors, such as a type and/or amount of cargo (e.g., passengers, products, and the like) being carried by the vehicles 108, sizes of the vehicles 108, sizes, masses, and/or weights of the vehicles 108, dependencies associated with the vehicles 108 (e.g., a dependency including travel of a first vehicle being dependent upon a second vehicle, such as a train that may need to wait for a mining vehicle to arrive and drop off cargo on the train), financial values of cargo being carried by the vehicles 108, financial value of shipping contracts associated with the vehicles 108 (e.g., the contracts by which the vehicles 108 carry the cargo to the destination locations), and the like.

The resolution module 212 may generate the alternate schedules based on a feasibility of getting the vehicles 108 to the scheduled designated locations. For example, the resolution module 212 may modify the candidate schedules so that the vehicles 108 are able to arrive at the destination locations of the candidate schedules, even if one or more of the vehicles 108 are unable to arrive at the destination locations at the scheduled arrival times of the candidate schedules. For example, as described above, the candidate schedules may result in the vehicles 108 being unable to reach the destination locations, such as when deadlock occurs. The resolution module 212 may modify the candidate schedules so that the vehicles 108 arrive at the scheduled destination locations, but according to alternate schedules that may result in one or more of the vehicles 108 arriving at a different time, such as later, than the scheduled arrival times, taking different paths to the scheduled destination locations, and the like.

In one embodiment, the scheduling module 208 and the resolution module 212 may create the schedules using different algorithms. For example, the scheduling module 208 may generate the candidate schedules using a first algorithm that determines movements of the vehicles 108 from a starting location to a destination location at an arrival time while the resolution module 212 uses a different, second algorithm to modify the candidate schedules into the alternate schedules or to otherwise create the alternate schedules. An algorithm may include one or more steps or operations that are performed to create a schedule based on input data. For example, an algorithm may create a candidate or alternate schedule using one or more calculations, decisions, or other steps or operations and based on input data such as a current or stating location of a vehicle 108, a previously scheduled arrival time, a destination location, a previously scheduled path along the route 102, and the like. Algorithms may differ from each other when one algorithm uses one or more different steps, operations, calculations, decisions, and the like, than another algorithm.

By way of example, the scheduling module 208 may create the candidate schedules using a first algorithm that creates candidate schedules based on destination locations and designated arrival times and/or relative priorities between the vehicles 108. For example, the scheduling module 208 may generate a first schedule for a first vehicle 108 to arrive at a first destination location before other vehicles 108 having lower priorities. The algorithm used by the scheduling module 208 may create the schedule such that the first vehicle 108 travels to the destination location using the shortest path, or at least a path that is shorter in distance than one or more other paths, for the first vehicle 108 to take to the destination location. The algorithm used by the scheduling module 208 may generate the candidate schedules based on a goal of getting the vehicles 108 to associated destinations in a designated order and/or a designated arrival times. Alternatively, the algorithm used by the scheduling module 208 may use another method or process to create the candidate schedule for the first vehicle 108.

The resolution module 212 may generate the alternate schedules using a second algorithm that creates alternate schedules. The second algorithm may be applied to a geographic subset of the transportation network 100, as described above. In contrast to the scheduling module 208, the resolution module 212 may create the alternate schedules in order to cause a plurality of the vehicles 108 to approach and/or travel through a geographic subset of the transportation network 100, such as the gridlock area 400 (shown in FIG. 4). For example, instead of the second algorithm applying a set of operations or steps that work to get the vehicles 108 to associated destination locations at designated arrival times and/or in a designated order, the second algorithm may apply operations or steps that determine alternate schedules that avoid creating or causing the gridlock area.

In one embodiment, the resolution module 212 uses one or more Linear Programming (LP) and/or an Integer Programming (IP) algorithms to create the alternate schedules while the scheduling module 208 uses one or more algorithms other than an LP and/or IP algorithm to create the candidate schedules. An IP algorithm may be a set of operations or steps that create a schedule (e.g., an alternate schedule) in which input data into the IP algorithm (such as an entrance order of vehicles 108, an exit order of vehicles 108, relative priorities of vehicles 108, and/or other information related to movement of the vehicles 108) for use as variables that are solved by the algorithm (e.g., linear equations that define movements of the vehicles 108) is restricted to integer values. A LP algorithm may be a set of operations or steps that create a schedule (e.g., an alternate schedule) in which the movements of the vehicles 108 are defined by a set of linear relationships between the vehicles 108. While LP and IP algorithms are used as examples, alternatively, other algorithms may be used.

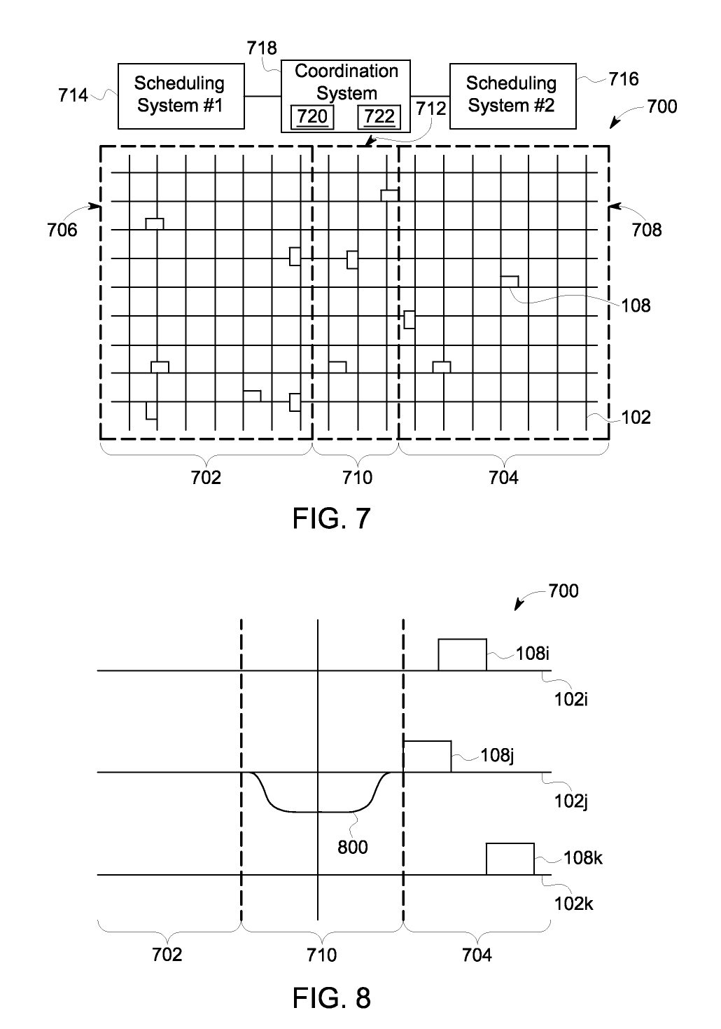

FIG. 7 is a schematic diagram of another embodiment of a transportation network 700. The transportation network 700 may be similar to the transportation network 100 (shown in FIG. 1), such as by including a plurality of interconnected routes 102 on which several vehicles 108 may concurrently travel. The transportation network 700 may be divided into different geographic areas 702, 704, such as different sub-areas of the transportation network 700. Alternatively, the geographic areas 702, 704 may represent different transportation networks 700. The geographic areas 702, 704 may be non-overlapping areas, as is shown in FIG. 7, or may be at least partially overlapping areas. The geographic areas 702, 704 may be at least partially surrounded or defined by boundaries 706, 708, which can be arbitrarily defined boundaries or geographic boundaries, such as the boundaries of a town or city, county, state, country, or other area.

In the illustrated embodiment, the geographic areas 702, 704 are spatially separated from each other by a third geographic area that is referred to herein as a boundary area 710. The boundary area 710 may be at least partially enclosed or defined by a boundary 712 and may extend from the boundary 706 of one geographic area 702 of the transportation network 700 to the boundary 708 of another geographic area 704 of the transportation network 700. With respect to the embodiment of the scheduling system 114 (shown in FIG. 1), the boundary area 710 may be at least part of the gridlock area 400 (shown in FIG. 4) with different sections of the transportation network 100 (shown in FIG. 1) that at least partially extend around the gridlock area 400 being the different geographic areas 702, 704. For example, the geographic area 702 may be a portion of the transportation network 100 on one side of the gridlock area 400 and the geographic area 704 may be a different portion of the transportation network 100 on another side of the gridlock area 400.

Different scheduling systems may be provided to create movement plans for vehicles 108 traveling in and/or between the geographic areas 702, 704 of the transportation network 700. For example, a first scheduling system 714 (“Scheduling System #1”) may create movement plans for movement of the vehicles 108 within, into, and/or out of the geographic area 702 and a second scheduling system 716 (“Scheduling System #2”) may create movement plans for movement of the vehicles 108 within, into, and/or out of the geographic area 704. One or both of the scheduling systems 714, 716 may be similar to the scheduling system 114 (shown in FIG. 1). Similar to the scheduling system 114, the scheduling systems 714, 716 can create and communicate schedules of the movement plans to the vehicles 108. As described above, the vehicles 108 include control systems 116 (shown in FIG. 1) that receive the schedules from the scheduling systems 714, 716 and generate control signals that may be used to control propulsion of the vehicles 108 through the transportation network 700.

In one embodiment, a coordination system 718 is provided that coordinates movement of the vehicles 108 within the boundary area 710 between the geographic areas 702, 704. The coordination system 718 can include one or more devices, controllers, and the like, having hardware and/or software components that operate to provide various functions. In the illustrated embodiment, the coordination system 718 includes a communication module 720 and a scheduling module 722. As shown in FIG. 7, the coordination system 718 can be disposed off-board the vehicles 108. The coordination system 718 is communicatively coupled with the scheduling systems 714, 716, such as by one or more wired and/or wireless communication pathways and/or networks. Alternatively, the coordination system 718 can be included in one or more of the scheduling systems 714, 716.

The coordination system 718 can create and communicate the schedules for travel within the boundary area 710 to the vehicles 108. For example, the communication module 720 of the coordination system 718 can include a wireless antenna (not shown, but similar to that of the scheduling system 114 shown in FIG. 1) that wirelessly transmits the schedules to the vehicles 108. Alternatively, the coordination system 718 may communicate the schedules to the vehicles 108 via another medium, such as through one or more conductive pathways (e.g., wires, cables, the rails of a railroad track, an overhead catenary, or the like).

The scheduling module 722 of the coordination system 718 may create a boundary set of schedules for the vehicles 108 that travel out of the geographic area 702 or 704, through the boundary area 710, and into the other of the geographic areas 704 or 702. The coordination system 718 may coordinate movement of the vehicles 108 by generating a movement plan that includes the boundary set of schedules for the vehicles 108 to move through the boundary area 710. The boundary set of schedules may direct the vehicles 108 to move to one or more destination locations disposed at an interface between the boundary 712 of the boundary area 710 and the boundary 706 or 708 of the geographic area 702 or 704, to move to the destination locations at associated arrival times, and/or one or more paths to take along the routes 102 in the boundary area 710 to reach the scheduled destination locations.

In one embodiment, the boundary set of schedules can include one or more events between two or more vehicles 108, such as a meet event, pass event, convergence event, and/or divergence event. As used herein, a meet event includes two or more vehicles 108 traveling in opposite directions on the same route 102 with at least one of the vehicles 108 moving off a main line route onto a siding section route to allow one or more other vehicles 108 to continue on the main line route. A pass event includes two or more vehicles 108 traveling in the same direction on the same route 102 with at least one of the vehicles 108 moving off the main line route onto a siding section route to allow one or more other vehicles 108 to pass on the main line route. A convergence event includes two or more vehicles 108 traveling on different routes 102 that converge into a single route 102 to move from the different routes 102 onto the single route 102 at scheduled times to avoid collision between the vehicles 102. A divergence event includes two or more vehicles 108 traveling on the same route 102 that splits into two or more divergent routes 102, with the vehicles 108 moving onto the divergent routes 102 at scheduled times.

In one embodiment, the coordination system 718 creates the schedules for the vehicles 108 traveling in or through the boundary area 710 based on the schedules of the vehicles 108 traveling in one or more of the geographic areas 702, 704. For example, the coordination system 718 can create the boundary set of schedules based on the schedules of the vehicles 108 leaving the geographic areas 702 and/or 704 and/or based on the schedules of the vehicles 108 entering into the geographic areas 702 and/or 704. The schedules of the vehicles 108 leaving a geographic area 702, 704 may be referred to as an exit set of schedules and the schedules of the vehicles 108 entering a geographic area 702, 704 may be referred to as an entrance set of schedules.

The exit set of schedules may include an order in which the vehicles 108 leave a geographic area 702 or 704 and enter into the boundary area 710. For example, an exit set of schedules for a group of the vehicles 108 may include the order in which the vehicles 108 cross the boundary 712 into the boundary area 710 and enter into the boundary area 710 within the group. The scheduling system 714, 716 associated with the geographic area 702, 704 from which the vehicles 108 of the exit set of schedules are leaving may communicate the movement plan having the schedules of the vehicles 108 traveling in and/or out of the geographic area 702, 704 to the coordination system 718. Based on the schedules received from the scheduling system 714, 716, the coordination system 718 may determine the exit order of the vehicles 108 out of the geographic area 702 or 704 and into the boundary area 710. For example, the coordination system 718 may examine the schedules of the vehicles 108 as received from the scheduling system 714, 716 to determine the times that the vehicles 108 are scheduled to enter into the boundary area 710 and, based on these times, determine the order in which the vehicles 108 are scheduled to exit the geographic area 702 and/or 704.

The exit set of schedules may be updated. For example, the scheduling system 714, 716 may update a previous set of schedules for the vehicles 108 traveling in the geographic areas 702, 704. The updated schedules may be communicated to the coordination system 718. The coordination system 718 may use the updated schedules to determine if the exit order of the vehicles 108 has changed. If the exit order has changed, then the coordination system 718 may update the exit order.

The entrance set of schedules may include an order in which the vehicles 108 leave the boundary area 710 to enter into a geographic area 702, 704. This order may be referred to as an entrance order. For example, an entrance set of schedules for a group of the vehicles 108 may include the order in which the vehicles 108 cross the boundary 712 from the boundary area 710 and exit the boundary area 710. The scheduling system 714, 716 associated with the geographic area 702, 704 into which the vehicles 108 are scheduled to travel may communicate the movement plan to the coordination system 718. Based on the schedules received from the scheduling system 714, 716, the coordination system 718 may determine the entrance order that the vehicles 108 are expected to enter into the geographic area 702, 704 by the scheduling system 714, 716 that generates the schedules for the vehicles 108 in the geographic area 702, 704. The scheduling systems 714, 716 may generate and/or update schedules for vehicles 108 traveling in the geographic area 702, 704 associated with the scheduling system 702, 704 based on the entrance order. For example, a scheduling system 715, 716 may create the movement plan for a geographic area 702, 704 that is based on a previously designated order of the vehicles 108 entering into the geographic area 702, 704. The designated order of the vehicles 108 may be the same as the entrance order.

In one embodiment, the coordination system 718 creates the boundary set of schedules of the vehicles 108 to travel within the boundary area 710 such that the entrance order of the vehicles 108 is maintained even when the travel of the vehicles 108 deviates from the exit set of schedules. For example, during actual travel of the vehicles 108 in a first geographic area 702, one or more vehicles 108 may fall behind schedule and/or cause the exit order in which the vehicles 108 leave the geographic area 702 to travel into the boundary area 710 to change from a previously scheduled exit order. The coordination system 718 may create schedules for the vehicles 108 to travel within the boundary area 710 such that the vehicles 108 leave the boundary area 710 and enter into the second geographic area 704 in the same entrance order that was previously established by the scheduling system 716. The coordination system 718 may create the boundary set of schedules such that, although the vehicles 108 may deviate from associated exit schedules which cause the vehicles 108 to enter into the boundary area 710 in a different order than previously scheduled, the boundary set of schedules provide for travel of the vehicles 108 within the boundary area 710 such that the vehicles 108 leave the boundary area 710 and enter into the geographic area 702, 704 in the previously designated entrance order.

With continued reference to the coordination system 718 described in FIG. 7, FIGS. 8 through 10 provide schematic diagrams of a portion of the transportation network 700 at different points in time according to one embodiment. FIG. 8 illustrates three vehicles 108i-k traveling in the geographic area 704. The vehicles 108i-k are scheduled to leave the geographic area 704 and travel to the geographic area 702 of the transportation network 700 through the boundary area 710.

In the illustrated example, the vehicles 108i-k are scheduled to leave the geographic area 704 according to an exit set of schedules. The scheduling system 714 (shown in FIG. 7) associated with the geographic area 702 has generated a movement plan for the vehicles 108i-k to travel in the geographic area 702 that is based on the vehicles 108i-k entering into the geographic area 702 in an entrance order. For example, the scheduling system 714 may have generated schedules for the vehicles 108i-k that are based on the first vehicle 108i entering the geographic area 702 from the boundary area 710 first, followed by the third vehicle 108k and then the second vehicle 108j.

As shown in FIG. 8, however, the vehicles 108i-k are traveling such that the second vehicle 108j may enter into the geographic area 702 first, followed by the first vehicle 108i and then the third vehicle 108k. In order to maintain the previously designated entrance order of the first vehicle 108i, then the third vehicle 108k, and then the second vehicle 108j, the coordination system 718 creates the boundary set of schedules for the vehicles 108i-k to travel in the boundary area 710. The boundary set of schedules may delay and/or speed up travel of one or more of the vehicles 108i-k in order to cause the vehicles 108i-k to enter into the geographic area 702 in the designated entrance order.

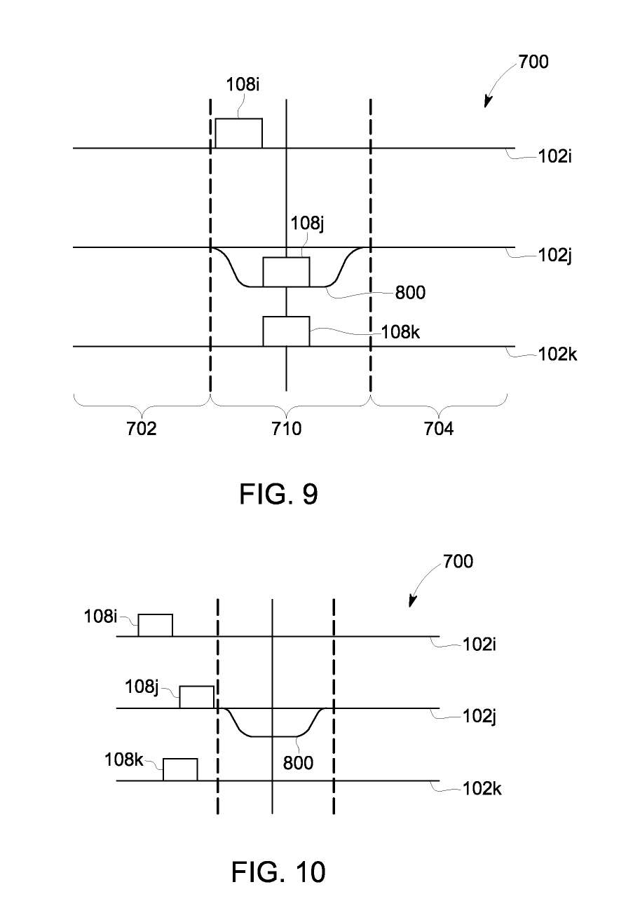

For example, the route 102j on which the second vehicle 108j is traveling may include a siding section route 800. The boundary set of schedules may direct the second vehicle 108j to pull onto the siding section route 800 (e.g., as shown in FIG. 9) for long enough before pulling back onto the route 102j to allow the first vehicle 108i and the third vehicle 108k to leave the boundary area 710 and enter into the geographic area 702 before the second vehicle 108j. The boundary set of schedules also may direct the third vehicle 108k to travel to the boundary 706, 712 between the boundary area 710 and the geographic area 702 at an earlier time than previously scheduled and/or to increase speed toward the geographic area 702 such that the third vehicle 108k enters into the geographic area 702 after the first vehicle 108i but before the second vehicle 108j. Alternatively, the boundary set of schedules may direct one or more of the vehicles 108i-k to enter into the geographic area 702 at earlier or later times, to participate in one or more meet events, pass events, divergence events, convergence events, and the like, take different paths within the boundary area 710, and the like, to cause the vehicles 108i-k to enter into the geographic area 702 in the entrance order.

The coordination system 718 may create the boundary set of schedules such that the exit order in which the vehicles 108 are received into the boundary area 710 is the same as the entrance order in which the vehicles 108 leave the boundary area 710. For example, the boundary area 710 may act as a buffer zone between different geographic areas 702, 704 that are associated with different movement plans created by different scheduling systems 714, 716. In order to prevent the differences between movement plans from disrupting the flow of traffic when the vehicles 108 transition between the geographic areas 702, 704, the boundary area 710 may be created and the coordination system 718 may create the schedules for travel in the boundary area 710 such that the order that the scheduling system 714 or 716 schedules vehicles 108 to leave the geographic area 702 or 704 is the same as the order that the scheduling system 716 or 714 schedules the vehicles 108 to enter into the geographic area 704 or 702.

In one embodiment, the coordination system 718 creates the boundary set of schedules such that the vehicles 108 travel through the boundary area 710 without significantly decreasing the flow of traffic through the transportation network 700. For example, the coordination system 718 may create the boundary set of schedules such that one or more throughput parameters of the transportation network 700 remain above a predetermined threshold, such as a non-zero threshold, as described above. The coordination system 718 may generate a candidate set of boundary schedules and simulate travel of the vehicles 108 according to the candidate set of boundary schedules, as described above in connection with the scheduling system 114 (shown in FIG. 1). The coordination system 718 may vary the candidate set of boundary schedules based on calculated throughput parameters, identified gridlock areas, and the like, as described above, in order to keep the throughput parameter of the transportation network 700 above the threshold, as described above.

In another embodiment, one or more of the scheduling systems 714, 716 is a timetable scheduling system. A timetable scheduling system can include a system that schedules the movements of the vehicles 108 based on designated times or time slots that the vehicles 108 are permitted to travel to a location or between locations. For example, a timetable scheduling system can schedule vehicles 108 to travel to different locations within a geographic area to pick up and/or drop off passengers and/or cargo at the different locations. One example of such a system can be a commuter train system having trains that travel at designated times.

The timetable scheduling system generates time-constrained schedules that limit which times are available for vehicles 108 to enter into and/or leave the geographic area associated with the timetable scheduling system. For example, the scheduling system 714 may be a timetable scheduling system that permits vehicles 108 to travel on one or more routes 102 in the geographic area 702 at or between designated times, or within designated time slots between the designated times.

The coordination system 718 may communicate with the timetable scheduling system to determine which times or time slots are available for vehicles 108 to be received into the associated geographic area. The coordination system 718 may generate the boundary set of schedules such that the vehicles 108 are not scheduled to exit the boundary area 710 and enter into the geographic area associated with the timetable scheduling system at times other than the times or time slots that are available for the vehicles 108. A time or time slot that is available for a vehicle 108 may include a time or period between designated times that is not previously scheduled for another vehicle 108 to be traveling on the same route 102 and/or at the same location.

In one embodiment, one of the scheduling systems 714, 716 is a timetable scheduling system while another of the scheduling systems 714, 716 is an adaptive scheduling system. An adaptive scheduling system includes a scheduling system that generates schedules for the travel of vehicles 108 within the geographic area 702, 704 associated with the adaptive scheduling system. The adaptive scheduling system may then modify one or more of the schedules, as described above. For example, the adaptive scheduling system can change some of the schedules based on one or more time-variant characteristics of travel of the vehicles 108 in the geographic area associated with the adaptive scheduling system. The time-variant characteristics can include a change in congestion of travel of the vehicles 108 in the geographic area, changes in topology in the routes traveled by the vehicles 108, changes in amounts of fuel carried by the vehicles 108 traveling in the geographic area, adherence (or a lack thereof) of the vehicles 108 to schedules assigned to the vehicles 108, and the like. The adaptive scheduling system can modify the schedules of the vehicles 108 as the vehicles 108 travel in the geographic area of the adaptive scheduling system in order to reduce congestion in the geographic area and to increase the flow of movement of the vehicles 108, such as by increasing the throughput parameter in the geographic area.

The coordination system 718 may act as a buffer between a timetable scheduling system and an adaptive scheduling system so that vehicles 108 can travel from a geographic area associated with the adaptive scheduling system to a geographic area associated with the timetable scheduling system without having a significantly negative impact on the flow of travel in the transportation network 700. For example, the coordination system 718 may generate the boundary set of schedules so that vehicles 108 can travel from the geographic area of adaptive scheduling system (where the travel of the vehicles 108 is not limited or constrained to predesignated times or time slots) to the geographic area of the timetable scheduling system (where entry of the vehicles 108 into the geographic area may be constrained to designated times or time slots), while maintaining one or more of an exit order or an entrance order, as described above.

The coordination system 718 can communicate the boundary set of schedules to the vehicles 108 for use by the vehicles 108 in traveling in the boundary area 710 between the geographic areas 702, 704. In one embodiment, the coordination system 718 directly communicates the boundary set of schedules to the corresponding vehicles 108 by transmitting the schedules to the vehicles 108 without the schedules first being communicated to either scheduling system 714, 716. Alternatively, the coordination system 718 may indirectly communicate the schedules to the vehicles 108 by transmitting the schedules to the scheduling system 714 and/or 716, which conveys the schedules to the vehicles 108. The vehicles 108 may then use the schedules to control travel of the vehicles 108 in the boundary area 710.

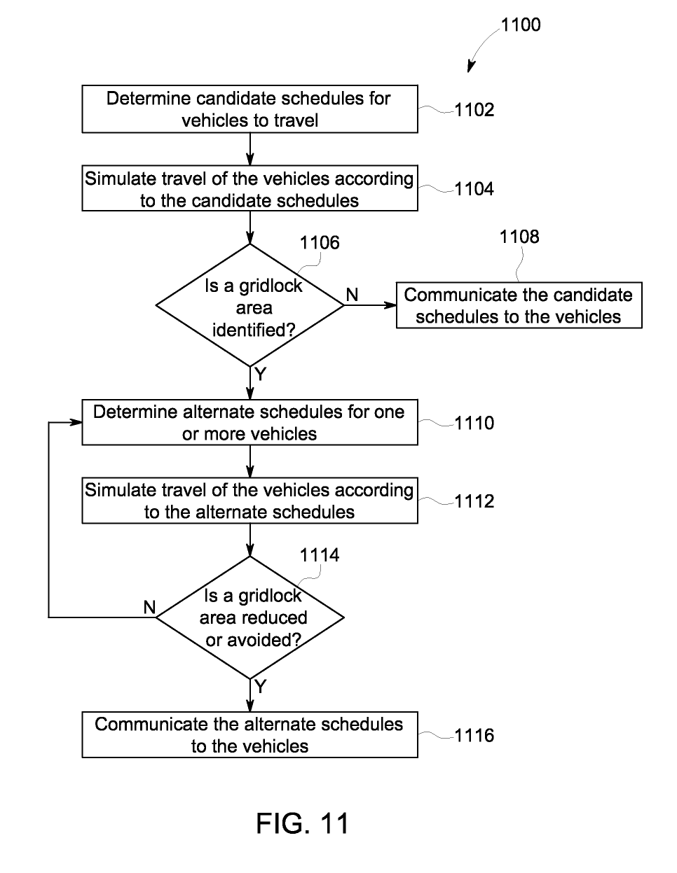

FIG. 11 illustrates a flowchart of one embodiment of a method 1100 for generating schedules for vehicles to travel in a transportation network. The method 1100 may be used in conjunction with one or more of the systems described herein. For example, the method 1100 may be used to create candidate schedules for vehicles to travel in a transportation network, simulate movement of the vehicles according to the candidate schedules, identify any gridlock areas, and to determine alternate schedules for one or more vehicles to avoid or reduce the severity of the gridlock areas. In one embodiment, the method 1100 may be used by the scheduling system 114 (shown in FIG. 1), as described above, and/or by the coordination system 718 (shown in FIG. 7) in order to create the boundary set of schedules described above.

At 1102, candidate schedules are determined for plural vehicles traveling in a transportation network. As described above, the candidate schedules may be generated based on relative priorities between the vehicles such that the vehicles arrive at scheduled destination locations at associated arrival times.

At 1104, travel of the vehicles according to the candidate schedules is simulated. For example, before communicating the candidate schedules to the vehicles for use in traveling in the transportation network, a computer, processor, controller, and/or network of computers, processors, or controllers may simulate the movements of the vehicles according to the candidate schedules.

At 1106, a determination is made as to whether a gridlock area occurs during the simulation of travel according to the candidate schedules. As described above, a gridlock area may be identified when a throughput parameter associated with the transportation network falls below a designated, non-zero threshold. Alternatively, the gridlock area may be identified when a number of backtracks from a deadlock in the simulation of travel according to the candidate schedules exceeds a designated threshold. In another embodiment, the gridlock area may be identified when a density of the vehicles in an area of the transportation network exceeds a designated threshold.

If no gridlock area is identified, then the candidate schedules may be useful to control travel of the vehicles in the transportation network without significantly restricting the flow of the vehicles through the transportation network. As a result, flow of the method 1100 may proceed to 1108, where the candidate schedules are communicated to the vehicles so that the vehicles can travel according to the candidate schedules.

On the other hand, if one or more gridlock areas are identified, then the candidate schedules may not be useable to control travel of the vehicles in the transportation network. As a result, flow of the method 1100 proceeds to 1110.

At 1110, one or more alternate schedules for the vehicles are created. As described above, the alternate schedules may be created by changing a destination location, scheduled arrival time, and/or path taken to travel to the destination location. In one embodiment, the boundary of the gridlock area may be identified and a scheduling algorithm that differs from the algorithm used to create the candidate schedules may be used to create schedules for the vehicles to travel within the gridlock area. The alternate schedules may be created such that at least one of an entrance order and/or an exit order of the vehicles into and/or out of the gridlock area does not change from the candidate schedules.

At 1112, simulation of travel by the vehicles according to the alternate schedules (where applicable) and the candidate schedules (e.g., for the vehicles having candidate schedules that are not modified into alternate schedules) is performed.

At 1114, a determination is made as to whether the simulated travel according to the alternate schedules (where applicable) and the candidate schedules (e.g., for the vehicles having candidate schedules that are not modified into alternate schedules) prevents the gridlock area from occurring or at least reduces the size and/or temporal duration of the gridlock area relative to that of the candidate schedules. If the gridlock area is not avoided or reduced due to the alternate schedules, then one or more of the alternate schedules may need to be further modified and/or one or more other candidate schedules may need to be modified. As a result, flow of the method 1100 may return to 1110.

On the other hand, if the gridlock area is avoided or reduced due to the alternate schedules, then the alternate schedules may be useful in directing actual travel of the vehicles in the transportation network. As a result, flow of the method 1100 may proceed to 1116.

At 1116, the alternate schedules (where applicable) and the candidate schedules (e.g., for the vehicles having candidate schedules that are not modified into alternate schedules) are communicated to the vehicles. The vehicles may receive the schedules and travel according to the schedules to avoid the gridlock area formerly identified in the transportation network.

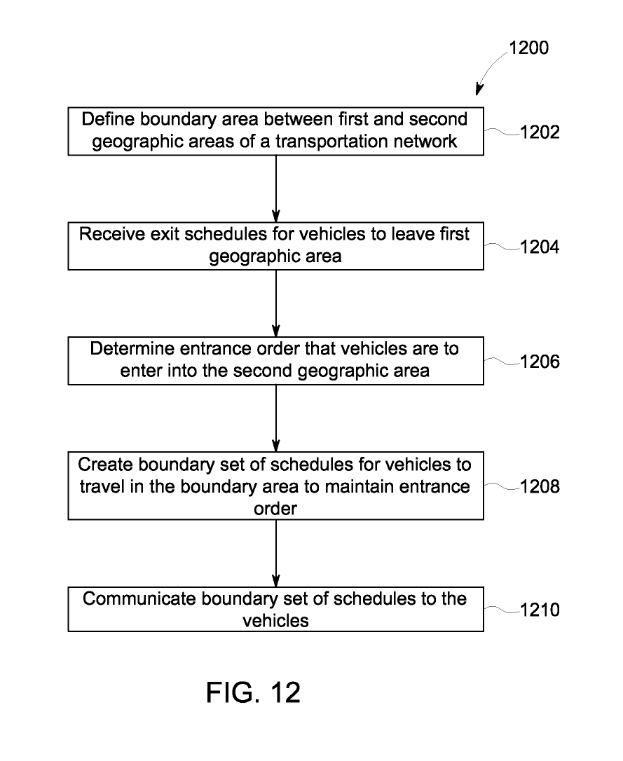

FIG. 12 is a flowchart of one embodiment of a method 1200 for generating schedules for vehicles to travel in a transportation network. The method 1200 may be used in conjunction with one or more of the systems described herein. For example, the method 1200 may be used by the scheduling system 114 (shown in FIG. 1) to create the alternate schedules used by the vehicles in the gridlock area, as described above, and/or by the coordination system 718 (shown in FIG. 7) in order to create the boundary set of schedules described above.

At 1202, a boundary area is defined between different geographic areas (e.g., first and second geographic areas) of a transportation network. In one embodiment, the geographic areas may be non-overlapping areas. Alternatively, the boundary area may be defined as a gridlock area in a simulation with a first geographic area may be on one side of a gridlock area identified during a simulation (as described above in connection with the scheduling system 114 of FIG. 1) while a second geographic area may be another area of the transportation network that is on another side of the gridlock area. The boundary area may be relatively small, such as a few miles or kilometers wide, or may be relatively large, such as several tens or hundred miles or kilometers wide.

At 1204, exit schedules at which vehicles are scheduled to leave a first geographic area (e.g., the geographic area 702 of FIG. 7 or the transportation network 100 on one side of the gridlock area 400 of FIG. 4) are received. The exit schedules may be received from the scheduling system that creates the schedules for the first geographic area.

At 1206, an entrance order in which the vehicles are to enter into a second geographic area (e.g., the geographic area 704 of FIG. 7 or the transportation network 100 on another side of the gridlock area 400 of FIG. 4) is determined. The entrance order may be based on the times at which the vehicles are scheduled to enter into the second geographic area.

At 1208, a boundary set of schedules are created. The boundary set of schedules direct travel of the vehicles in the boundary area, as described above. In one embodiment where travel of the vehicles deviates from the exit schedules, the boundary set of schedules may rearrange the vehicles such that the vehicles may leave the first geographic area in an order that is different from a scheduled exit order but that enter the second geographic area in the same order as a previously scheduled entrance order, as described above. The entrance order may be the same as the exit order in one or more embodiments.

At 1210, the boundary set of schedules are communicated to the vehicles. For example, the boundary set of schedules may be transmitted directly or indirectly to the vehicles so that the vehicles may travel from the first geographic area to the second geographic area through the boundary area while keeping a previously scheduled entrance order into the second geographic area. Keeping the same entrance order may avoid a need to make significant changes to the schedules of other vehicles traveling in the second geographic area if the vehicles traveling through the boundary area fall behind schedule.

In another embodiment, a method is provided that includes determining candidate schedules for plural vehicles traveling in a transportation network comprising interconnected routes over which the vehicles concurrently travel and identifying a gridlock area in the transportation network by simulating travel of the vehicles according to the candidate schedules. The gridlock area includes a geographic subset of the transportation network during a time window having at least a predetermined number of failed candidate schedules that result in a decrease of a throughput parameter. The throughput parameter represents flow of travel of the vehicles in the transportation network. The method also includes determining an alternate schedule that differs from the candidate schedule for one or more of the plural vehicles (e.g., a first vehicle of the plural vehicles) that is traveling through the gridlock area. The alternate schedule dictates travel of the one or more of the plural vehicles (e.g., the first vehicle) without decreasing the throughput parameter of the transportation network.

In another aspect, identifying the gridlock area includes determining the geographic subset of where the one or more of the plural vehicles becomes deadlocked in one or more simulations of the candidate schedules and determining the time window when the one or more of the plural vehicles becomes deadlocked.

In another aspect, identifying the gridlock area includes determining the geographic subset based on a density of the plural vehicles traveling in the transportation network exceeds a traffic threshold and determining the time window as a time during which the density exceeds the traffic threshold.

In another aspect, determining the candidate schedules includes using a first resolution algorithm to form the candidate schedules and determining the alternate schedules includes applying a different, second algorithm to the candidate schedules of said one or more of the plural vehicles.

In another aspect, determining the alternate schedules includes identifying a geographic boundary of the gridlock area, determining an order of any of the plural vehicles that cross the geographic boundary during the time window of the gridlock area, and forming the alternate schedules based on the order of the vehicles.

In another aspect, the alternate schedules are formed such that the order in which the vehicles cross the geographic boundary of the gridlock area is the same for the candidate schedules in which the vehicles enter into the gridlock area and for the alternate schedules in which the vehicles enter into the gridlock area.

In another embodiment, a system is provided that includes a scheduling module, a detection module, and a resolution module. The scheduling module is configured to determine candidate schedules for plural vehicles traveling in a transportation network comprising interconnected routes over which the vehicles concurrently travel. The detection module is configured to identify a gridlock area in the transportation network by simulating travel of the vehicles in the transportation network according to the candidate schedules. The gridlock area includes a geographic subset of the transportation network during a time window having at least a predetermined number of failed candidate schedules that result in a decrease of a throughput parameter representative of flow of travel of the vehicles traveling through the transportation network. The resolution module is configured to determine alternate schedules that differ from the candidate schedules for one or more of the plural vehicles that are traveling through the gridlock area. The alternate schedules dictate travel of said one or more of the plural vehicles without decreasing the throughput parameter.

In another aspect, the detection module is configured to identify the gridlock area by determining the geographic subset of where the one or more of the plural vehicles becomes deadlocked in one or more simulations of the candidate schedules and determining the time window when the one or more of the plural vehicles becomes deadlocked.

In another aspect, the detection module is configured to identify the gridlock area based on a density of the plural vehicles in the transportation network exceeds a traffic threshold and determining the time window as a time during which the density exceeds the traffic threshold.

In another aspect, the scheduling module is configured to form the candidate schedules using a first resolution algorithm and the resolution module is configured to determine the alternate schedules by applying a different, second algorithm to the candidate schedules of the one or more of the plural vehicles.

In another aspect, the resolution module is configured to identify a geographic boundary of the gridlock area, determine an order of any of the plural vehicles that cross the geographic boundary during the time window of the gridlock area, and form the alternate schedules based on the order of the vehicles.

In another aspect, the resolution module is configured to form the alternate schedules such that the order in which the vehicles cross the geographic boundary of the gridlock area is the same for the candidate schedules in which the vehicles enter into the gridlock area and for the alternate schedules in which the vehicles enter into the gridlock area.

In another embodiment, another method is provided that includes receiving an exit set of schedules associated with vehicles leaving a first geographic area of a transportation network comprising interconnected routes over which the vehicles travel, receiving an entrance order in which the vehicles are scheduled to enter into a different, second geographic area of the transportation network, and determining a boundary set of schedules for the vehicles to travel in a geographic boundary area of the transportation network that is disposed between the first geographic area and the second geographic area. The boundary set of schedules coordinate travel of the vehicles between the first geographic area and the second geographic area such that the entrance order of the vehicles into the second geographic area is maintained when the vehicles deviate from the exit set of schedules.

In another aspect, the boundary set of schedules are determined such that a throughput parameter representative of flow of the vehicles through the transportation network is maintained above a predetermined non-zero threshold.

In another aspect, determining the boundary set of schedules includes coordinating travel of the vehicles in the boundary area such that an exit order in which the vehicles leave the first geographic area is the same as the entrance order that the vehicles are scheduled to enter into the second geographic area.

In another aspect, the boundary set of schedules delay entry of the vehicles into the second geographic area relative to previously scheduled entry times for the vehicles to enter into the second geographic area.

In another aspect, determining the boundary set of schedules includes scheduling one or more meet events or pass events for the vehicles in the boundary area. In another aspect, determining the boundary set of schedules includes scheduling the vehicles to enter into the second geographic area in one or more available time slots of a plurality of predetermined time slots of at least one time-constrained schedule associated with the second geographic area.

In another aspect, the method also includes scheduling the vehicles for entry into the second geographic area only at the predetermined time slots.

In another aspect, the method also includes generating the first set of schedules based on one or more time-variant characteristics of travel of the vehicles in the first geographic area.

In another aspect, the time-variant characteristics include one or more of congestion of the vehicles in the first geographic area, changes in topology of the routes in the first geographic area, changes in amounts of fuel carried by the vehicles traveling in the first geographic area, or adherence to the first set of schedules by the vehicles traveling in the first geographic area.

In another embodiment, another system is provided that includes a communication module and a scheduling module. The communication module is configured to receive an exit set of schedules associated with vehicles leaving a first geographic area of a transportation network comprising interconnected routes over which the vehicles travel and configured to receive an entrance order in which the vehicles are scheduled to enter into a different, second geographic area of the transportation network. The scheduling module is configured to determine a boundary set of schedules for the vehicles to travel in a geographic boundary area of the transportation network that is disposed between the first geographic area and the second geographic area. The scheduling module also is configured to coordinate travel of the vehicles between the first geographic area and the second geographic area such that the entrance order of the vehicles into the second geographic area is maintained when the vehicles deviate from the exit set of schedules.

In another aspect, the scheduling module is configured to determine the boundary set of schedules such that a throughput parameter representative of flow of the vehicles through the transportation network is maintained above a predetermined non-zero threshold.

In another aspect, the scheduling module is configured to coordinate travel of the vehicles in the boundary area such that an exit order in which the vehicles leave the first geographic area is the same as the entrance order that the vehicles are scheduled to enter into the second geographic area.

In another aspect, the scheduling module is configured to determine the boundary set of schedules in order to delay entry of the vehicles into the second geographic area relative to previously scheduled entry times for the vehicles to enter into the second geographic area.

In another aspect, the scheduling module is configured to schedule one or more meet events or pass events for the vehicles in the boundary area.

In another aspect, the second geographic area is associated with a timetable scheduling system that is configured to generate time-constrained schedules having predetermined time slots for the vehicles to travel in the second geographic area, and wherein the scheduling module is configured to schedule the vehicles to enter into the second geographic area in one or more available time slots of the predetermined time slots in the time-constrained schedules.

In another aspect, the timetable scheduling system of the second geographic area only accepts the vehicles into the second geographic area at the predetermined time slots.

In another aspect, the first geographic area is associated with an adaptive scheduling system that generates the first set of schedules and based on one or more time-variant characteristics of travel of the vehicles in the first geographic area.

In another aspect, the time-variant characteristics include one or more of congestion of the vehicles in the first geographic area, changes in topology of the routes in the first geographic area, changes in amounts of fuel carried by the vehicles traveling in the first geographic area, or adherence to the first set of schedules by the vehicles traveling in the first geographic area.

In any of the embodiments set forth herein relating to a method, one or more of the steps of the method may be carried out automatically by a machine as described herein. Additionally, according to another aspect, a technical effect is to control vehicles for movement in a transportation network based on received schedules, where the schedules are generated as described herein to improve traffic throughput (versus controlling the vehicles otherwise) and/or to decrease the time or computational power required to generate the schedules (relative to generating the schedules otherwise).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter, including the best mode, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

1. A method comprising:
determining candidate schedules for plural vehicles traveling in a transportation network comprising interconnected routes over which the vehicles concurrently travel;
identifying a gridlock area in the transportation network by simulating travel of the vehicles according to the candidate schedules using one or more processors, the gridlock area including a geographic subset of the transportation network during a time window having at least a predetermined number of failed candidate schedules that result in a decrease of a throughput parameter, the throughput parameter being representative of flow of travel of the vehicles in the transportation network; and
determining an alternate schedule that differs from the candidate schedule for one or more of the plural vehicles that are traveling through the gridlock area, the alternate schedule dictating travel of said one or more of the plural vehicles without decreasing the throughput parameter of the transportation network.

2. The method of claim 1, wherein identifying the gridlock area includes determining the geographic subset of where the one or more of the plural vehicles becomes deadlocked in one or more simulations of the candidate schedules and determining the time window when the one or more of the plural vehicles becomes deadlocked.

3. The method of claim 1, wherein identifying the gridlock area includes determining the geographic subset based on where a density of the plural vehicles traveling in the transportation network exceeds a traffic threshold and determining the time window as a time during which the density exceeds the traffic threshold.

4. The method of claim 1, wherein determining the candidate schedules includes using a first resolution algorithm to form the candidate schedules and determining the alternate schedules includes applying a different, second algorithm to the candidate schedules of said one or more of the plural vehicles.

5. The method of claim 1, wherein determining the alternate schedules includes: identifying a geographic boundary of the gridlock area; determining an order of any of the plural vehicles that cross the geographic boundary during the time window of the gridlock area; and forming the alternate schedules based on the order of the vehicles.

6. The method of claim 5, wherein the alternate schedules are formed such that the order in which the vehicles cross the geographic boundary of the gridlock area is the same for the candidate schedules in which the vehicles enter into the gridlock area and for the alternate schedules in which the vehicles enter into the gridlock area.

7. A system comprising:
a scheduling module configured to determine candidate schedules for plural vehicles traveling in a transportation network comprising interconnected routes over which the vehicles concurrently travel;
a detection module including one or more processors configured to identify a gridlock area in the transportation network by simulating travel of the vehicles in the transportation network according to the candidate schedules, the gridlock area including a geographic subset of the transportation network during a time window having at least a predetermined number of failed candidate schedules that result in a decrease of a throughput parameter representative of flow of travel of the vehicles through the transportation network; and
a resolution module configured to determine alternate schedules that differ from the candidate schedules for one or more of the plural vehicles that are traveling through the gridlock area, the alternate schedules dictating travel of said one or more of the plural vehicles without decreasing the throughput parameter of the transportation network.

8. The system of claim 7, wherein the detection module is configured to identify the gridlock area by determining the geographic subset of where the one or more of the plural vehicles becomes deadlocked in one or more simulations of the candidate schedules and determining the time window when the one or more of the plural vehicles becomes deadlocked.

9. The system of claim 7, wherein the detection module is configured to identify the gridlock area based on where a density of the plural vehicles in the transportation network exceeds a traffic threshold and determining the time window as a time during which the density exceeds the traffic threshold.

10. The system of claim 7, wherein the scheduling module is configured to form the candidate schedules using a first resolution algorithm and the resolution module is configured to determine the alternate schedules by applying a different, second algorithm to the candidate schedules of the one or more of the plural vehicles.

11. The system of claim 7, wherein the resolution module is configured to identify a geographic boundary of the gridlock area, determine an order of any of the plural vehicles that cross the geographic boundary during the time window of the gridlock area, and form the alternate schedules based on the order of the vehicles.

12. The system of claim 11, wherein the resolution module is configured to form the alternate schedules such that the order in which the vehicles cross the geographic boundary of the gridlock area is the same for the candidate schedules in which the vehicles enter into the gridlock area and for the alternate schedules in which the vehicles enter into the gridlock area.

13. A method comprising:
receiving an exit set of schedules associated with vehicles leaving a first geographic area of a transportation network comprising interconnected routes over which the vehicles travel;
receiving an entrance order in which the vehicles are scheduled to enter into a different, second geographic area of the transportation network; and
using one or more processors, determining a boundary set of schedules for the vehicles to travel in a geographic boundary area of the transportation network that is disposed between the first geographic area and the second geographic area, the boundary set of schedules coordinating travel of the vehicles between the first geographic area and the second geographic area such that the entrance order of the vehicles into the second geographic area is maintained when the vehicles deviate from the exit set of schedules.

14. The method of claim 13, wherein the boundary set of schedules are determined such that a throughput parameter representative of flow of the vehicles through the transportation network is maintained above a predetermined non-zero threshold.

15. The method of claim 13, wherein determining the boundary set of schedules includes coordinating travel of the vehicles in the boundary area such that an exit order in which the vehicles leave the first geographic area is the same as the entrance order that the vehicles are scheduled to enter into the second geographic area.

16. The method of claim 13, wherein the boundary set of schedules delay entry of the vehicles into the second geographic area relative to previously scheduled entry times for the vehicles to enter into the second geographic area.

17. The method of claim 13, wherein determining the boundary set of schedules includes scheduling one or more meet events or pass events for the vehicles in the boundary area.

18. The method of claim 13, wherein determining the boundary set of schedules includes scheduling the vehicles to enter into the second geographic area in one or more available time slots of a plurality of predetermined time slots of at least one time-constrained schedule associated with the second geographic area.

19. The method of claim 18, further comprising scheduling the vehicles for entry into the second geographic area only at the predetermined time slots.

20. The method of claim 18, further comprising generating the first set of schedules based on one or more time-variant characteristics of travel of the vehicles in the first geographic area.

21. The method of claim 20, wherein the time-variant characteristics include one or more of congestion of the vehicles in the first geographic area, changes in topology of the routes in the first geographic area, changes in amounts of fuel carried by the vehicles traveling in the first geographic area, or adherence to the first set of schedules by the vehicles traveling in the first geographic area.

22. A system comprising:
a communication module configured to receive an exit set of schedules associated with vehicles leaving a first geographic area of a transportation network comprising interconnected routes over which the vehicles travel and configured to receive an entrance order in which the vehicles are scheduled to enter into a different, second geographic area of the transportation network; and
a scheduling module comprising one or more processors configured to determine a boundary set of schedules for the vehicles to travel in a geographic boundary area of the transportation network that is disposed between the first geographic area and the second geographic area, the scheduling module configured to coordinate travel of the vehicles between the first geographic area and the second geographic area such that the entrance order of the vehicles into the second geographic area is maintained when the vehicles deviate from the exit set of schedules.

23. The system of claim 22, wherein the scheduling module is configured to determine the boundary set of schedules such that a throughput parameter representative of flow of the vehicles through the transportation network is maintained above a predetermined non-zero threshold.

24. The system of claim 22, wherein the scheduling module is configured to coordinate travel of the vehicles in the boundary area such that an exit order in which the vehicles leave the first geographic area is the same as the entrance order that the vehicles are scheduled to enter into the second geographic area.

25. The system of claim 22, wherein the scheduling module is configured to determine the boundary set of schedules in order to delay entry of the vehicles into the second geographic area relative to previously scheduled entry times for the vehicles to enter into the second geographic area.

26. The system of claim 22, wherein the scheduling module is configured to schedule one or more meet events or pass events for the vehicles in the boundary area.

27. The system of claim 22, wherein the second geographic area is associated with a timetable scheduling system that is configured to generate time-constrained schedules having predetermined time slots for the vehicles to travel in the second geographic area, and wherein the scheduling module is configured to schedule the vehicles to enter into the second geographic area in one or more available time slots of the predetermined time slots in the time-constrained schedules.

28. The system of claim 27, wherein the timetable scheduling system of the second geographic area only accepts the vehicles into the second geographic area at the predetermined time slots.

29. The system of claim 27, wherein the first geographic area is associated with an adaptive scheduling system that generates the first set of schedules and based on one or more time-variant characteristics of travel of the vehicles in the first geographic area.

30. The system of claim 29, wherein the time-variant characteristics include one or more of congestion of the vehicles in the first geographic area, changes in topology of the routes in the first geographic area, changes in amounts of fuel carried by the vehicles traveling in the first geographic area, or adherence to the first set of schedules by the vehicles traveling in the first geographic area.
